(19) United States
(12) Patent Application Publication
(10) Pub. No.: US 2025/0342476 A1
(43) Pub. Date: Nov. 6, 2025

(54) SYSTEMS AND METHODS FOR FRAUD CONTROLS FOR AUTOMATED TRANSACTION MACHINES

(71) Applicant: Wells Fargo Bank, N.A., San Francisco, CA (US)

(72) Inventors: Jonathan Baker, San Francisco, CA (US); Frank DiGangi, San Francisco, CA (US); Nicolai J. Lesko, San Francisco, CA (US); Stephen George Mueller, San Francisco, CA (US); Heather Cobb Smith, San Francisco, CA (US); David Winner, San Francisco, CA (US)

(73) Assignee: Wells Fargo Bank, N.A., San Francisco, CA (US)

(21) Appl. No.: 18/655,126

(22) Filed: May 3, 2024

(51) Int. Cl. G06Q 20/40

(52) U.S. Cl. CPC G06Q 20/4016; G06Q 40/024; G06Q 40/029

(57) ABSTRACT

Systems and methods relate to an automated teller machine (ATM) associated with a provider institution computer system. The ATM system includes a processor and a memory having instructions thereon that cause the processor to: receive, via an input device and in a first instance, a first user input from a user of the ATM regarding a first transaction; identify at least: one or more factors associated with the user, and user account data; in a second instance subsequent to the first instance, provide a second transaction including one or more products, the products determined based on at least the factors associated with the user and the user account data; and cause a graphical user interface (GUI) of the ATM to display the products. The ATM may also include a storage repository to store non-monetary media and a card preparation apparatus to convert the non-monetary media into a transaction media.

### TECHNICAL FIELD

The present disclosure relates to apparatuses, systems, and methods for providing expanded products, functionalities, and security at transaction devices, such as automated teller machines (ATMs).

### BACKGROUND

ATMs are a convenient way for customers (e.g., cardholders of a financial institution) to complete financial transactions, including document deposits, banknote deposits and the like. ATMs may be placed and accessed by customers at various geographic locations, such as bank locations, convenience stores, other stores, or standalone kiosks to facilitate a customer's interaction with the banking systems. ATMs accept transaction media such as debit cards, credit cards, or stored value cards that are often used by customers to purchase items or services or to obtain funds. During normal operation, ATMs may dispense banknotes during withdrawal transactions or receive checks and/or banknotes during deposit transactions. However, users may be unable to complete some transactions, such as those involving a monetary value above a transaction threshold and experience a hold or other delay before certain ATM transactions can be completed. Additionally, ATM systems provide relatively little integration with fraud control functionalities and customers must often schedule an appointment with a banker or go to online banking to, for example, replace a lost or stolen transaction card or acquire certain products. Thus, users are not able to use an ATM of the financial institution for certain transactions, for card recovery, or the like.

### SUMMARY

One embodiment of the disclosure relates to an automated teller machine (ATM) associated with a provider institution computer system. The system at least one first processor and at least one first memory having instructions stored thereon that when executed by the at least one first processor, cause the at least one first processor to: receive, via an input device and in a first instance, a first user input from a user of the ATM regarding a first transaction; identify at least: one or more factors associated with the user, and user account data; in a second instance subsequent to the first instance, provide a second transaction including one or more products, the one or more products determined based on at least the one or more factors associated with the user and the user account data; and cause a graphical user interface (GUI) of the ATM to display the one or more products.

Another embodiment of the present disclosure relates a system including an automated teller machine (ATM) associated with a provider institution computer system. The system includes a storage repository configured to store at least one non-monetary media and a card preparation apparatus configured to convert the at least one non-monetary media into a transaction media for a user of the ATM. The ATM also includes at least one first processor and at least one first memory having instructions stored thereon that, when executed by the at least one first processor, cause the at least one first processor to: receive, via an input device, a first user input indicating that a transaction medium is compromised; receive, at the ATM, a request to recover the transaction medium; responsive to receiving the request to recover the transaction medium, activate one or more ATM fraud controls; provide a notification indicative of the one or more ATM fraud controls; and responsive to authenticating the user of the ATM, provide, by the ATM, an additional transaction medium.

A further embodiment of the present disclosure relates to a method of operation for an automated teller machine (ATM). The method includes the steps of receiving, via an input device and in a first instance, a first user input from a user of an ATM regarding a first transaction; identifying at least: one or more factors associated with the user, and user account data; identifying at least one of: that the first transaction involves a first transaction value satisfying a threshold value, or that at least one of the one or more factors associated with the user or the user account data comprises a trigger condition; responsive to identifying at least one of that the first transaction involves the first transaction value satisfying the threshold value or identifying the trigger condition, receiving one or more products, the one or more products determined based on at least the one or more factors associated with the user or the user account data; in a second instance subsequent to the first instance, providing a second transaction including the one or more products; causing a graphical user interface (GUI) of the ATM to display the one or more products; and performing the second transaction responsive to receiving a second user input.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of a transaction computing system, according to an example embodiment;

FIG. 2 is a is a block diagram of an ATM system, according to an example embodiment;

FIG. 3 is a front elevated view of the ATM system of FIG. 2, according to an example embodiment;

FIG. 4 is a front lower view of the transaction device of FIG. 2 with certain internal zones shown within dashed boxes, according to an example arrangement;

FIG. 5 is a flowchart illustrating a method for generating and providing a product via an ATM having a secure second instance, according to an example embodiment;

FIG. 6 is a flowchart illustrating another embodiment of the method for generating and providing a product via an ATM having a secure second instance;

FIG. 7 is a flowchart illustrating another embodiment of the method for generating and providing a product via an ATM having a secure second instance;

FIG. 8 is a flowchart illustrating a method for implementing enhanced fraud controls and card recovery via an ATM system of FIG. 2;

FIG. 9 illustrates example user interfaces of an ATM interoperable with the methods of FIGS. 5, 6, 7, and 8, according to an example embodiment; and

FIGS. 10A and 10B illustrate additional example user interfaces of an ATM interoperable with the methods of FIGS. 5, 6, 7, and 8, according to an example embodiment.

### DETAILED DESCRIPTION

Current ATM systems do not offer products and functionalities that provide users (e.g., customers and/or non-customers of the ATM provider) with tailored/specialized products (e.g., a microloan), enhanced fraud detection/security functionalities, or associated benefits by utilizing the ATM. The widespread availability of ATM systems and their ability to communicate with financial institution computer systems, third-party computer systems, and the like makes ATM systems an easily accessible medium capable of providing products and functionalities beyond traditional financial transactions to both customers of a financial institution and to non-customers. Accordingly, the present disclosure relates to ATM systems capable of performing expanded functionalities that benefit both customers of the financial institution associated with the ATM and non-customers of the financial institution. In this way, the current disclosure provides a technical solution to increase the security of ATM transactions by adding additional instances through which the identity of the user of the ATM may be authenticated and via which one or more products may be offered in a secure second instance (e.g., an instance accessible through a heightened layer of security). This disclosure also provides a technical solution that increases the financial flexibility of ATM users by allowing additional and enhanced transactions to become available, accessed, generated, or the like at the ATM. For example, in the secure second instance, an ATM user may acquire a product such as a microloan to prevent a hold/delay on a transaction or to increase their access to funds.

In this way, and as discussed herein, ATM systems may include additional instances to provide products to verified users. The products may include the generation of microloans and related analysis in real time for an ATM transaction involving a transaction value satisfying a transaction threshold. The ATM may provide an authenticated user immediate access to funds without requiring delay and/or a hold on the transaction. The ATM systems may also provide products (e.g., microloans) and/or expanded functionalities in real time based on detected account details. For example, if a customer deposits a check for $2,500, and wishes to make an immediate withdrawal of $2,000, but only has an account balance of $1000, a microloan may be generated to cover the $1,000 difference between the account balance and the amount of presently available funds. Whether or to what extent interest is charged on the microloan may be made dependent on whether the check successfully clears. Such detected account details may include, for example, a number of overdrafts within a set period of time, a balance below a balance limit, etc. Further, the systems and methods described herein may pre-approve a user for one or more products requiring a heightened layer of security and perform initial product analysis and/or generation before the user approaches the ATM. Upon detecting the user at the ATM and/or detecting a first transaction associated with the user, the ATM system may authenticate and/or offer the products (e.g., microloans) to the user. Product pre-approval may be based on the user's transaction history, based on user information, user account data, and/or any other suitable information. Additionally, the ATM systems, products, and expanded functionalities may enable improved fraud controls, card recovery, and improved security via the ATM interface. Such expanded functionalities may include receiving an indication that a card is lost/stolen, authenticating a user identity, and generating temporary or permanent account access credentials (e.g., via a replacement debit card or the like printed/generated at the ATM). While reference is sometimes made to the ATM for convenience, it will be understood that the operations described herein as being performed at the ATM may be performed at the ATM itself and/or elsewhere in the ATM system, such as by backend systems (e.g., computing system 104).

The ATMs for providing additional secure instances, associated products, and improved security functionalities for a customer and/or non-customer may enable one or more ATM transactions which may include, but are not limited to, providing microloans when a customer is attempting to withdraw or deposit more than a predefined amount and implementing fraud/security controls given these enhanced capabilities. In some embodiments, the ATM may receive transaction media, a card, other token, and/or user input indicative of fraud, determine that the transaction includes an indication of fraud, and collect/send data (e.g., snap a photo of the user and send the photo along with its location and the current time) to the proper authorities for investigative purposes. In some embodiments, the ATM may assist with compromised transaction media by dispensing new permanent and/or temporary transaction media to an ATM user after receiving an indication that a transaction medium of the user is compromised (e.g., lost or stolen), authenticating the user's identity, and the like.

Beneficially, the transaction devices (e.g., the ATMs) disclosed herein include also improved graphical user interfaces (GUIs) allowing access to additional ATM products, secure instances, and improved fraud and security controls for ATM transactions. The GUIs, products, and functionalities may, at least, provide technical solutions such as facilitating transactions without the implementation of holds though confirmation of a user's identity and generation of tailored products based on information received regarding a first transaction of the user. Additionally, the technical solutions herein streamline the card recovery process while also heightening security and providing financial flexibility to users of an ATM by generating a permanent and/or temporary card upon authentication of the user. Further, the ATM devices disclosed herein provide increased financial flexibility to the user of the ATM by generating, pre-approving, offering, etc. products at the ATM tailored to the ATM user. (Again, while reference is sometimes made to the ATM for convenience, it will be understood that the operations described herein may be performed at the ATM itself and/or elsewhere in the ATM system, such as by backend systems (e.g., computing system 104).) Such products may be available because of the additional instances (e.g., provided at the ATM) that improve the ability to detect fraud and secure a user account. For example, the financial products may include microloans having a balance and interest rate and/or defining a product structure. This microloan creation process and related products may allow ATM users to conduct, at the ATM, a previously prohibited transaction and/or transactions that would traditionally cause delay or place a hold on the user's account. Other technical solutions and benefits of the disclosure may be readily apparent from the discussion and illustrative examples of certain embodiments provided herein.

As utilized herein, a “customer” refers to an individual, business, entity, etc. that has registered as an account holder with the financial institution associated with the ATM, is a cardholder of the financial institution associated with the ATM, or the like. For example, a “customer” of Bank A has an established a relationship with Bank A by opening an account and utilizing the various financial services offered by Bank A. A “customer” includes an individual who has registered via Bank A's website and has opened a checking and/or savings account with Bank A. Additionally, a “customer” of Bank A includes an individual who is a cardholder of Bank A and may utilize the ATMs of Bank A by inserting their card, entering a PIN/passcode, etc. A “non-customer” refers to an individual, business, entity, etc. that has not registered as a checking/savings account holder with the financial institution associated with the ATM, is not a cardholder of the financial institution associated with the ATM, or the like. A “non-customer” does not have access to the various services offered by the bank beyond basic public services or may only have access to services encumbered by non-customer restrictions (e.g., transaction limits, geographical limitations, additional fees, etc.). For example, a “non-customer” of Bank A includes an individual who is registered with and owns a checking/savings account with Bank B and not Bank A, an individual who is not a cardholder of Bank A, an individual who transacts with Bank A on a limited basis, and the like.

Also, as used herein, an “instance” may refer to an occurrence or event associated with the ATM system. Further, an “instance” may also refer to applications and/or executables stored, hosted, or otherwise provided on a computing system (e.g., an ATM computing system). Non-limiting examples of an “instance” may refer to a transaction, a presentation of and/or access to a virtual environment, a request for and/or receipt of a user input, a presentation of selections for a user, an offering of products to a user, an opportunity to change/enable/disable/revise one or more settings, an authentication process, or the like. For example, a user withdrawing funds in a first instance may include one or more of the event(s) of receiving commands at the ATM and withdrawing funds from the account, the presentation of interfaces associated with withdrawing funds from the account, the sending/receiving of one or more inputs/outputs associated withdrawing funds from the account, or the like.

Also, as used herein, a “microloan” may refer to a product having a balance, at least one restriction, and/or defining a product structure. The balance may include a monetary amount to be paid to and/or paid back by an ATM user. For example, in some embodiments, the balance may include $50, $200, $500, $1,000, $10,000 or the like provided to a user of the ATM. In other embodiments, the balance may include $25,000, $50,000, or the like provided to the user. The at least one restriction may include an interest rate and/or a fee associated with receiving the product and/or applied with the product. In some embodiments, “microloan” may generally refer to a small-scale advance designed for individuals or small businesses who may not qualify for traditional bank financing. For example, the products may be utilized and/or targeted to support entrepreneurial endeavors, small-scale enterprises, or personal needs. The product structure may be defined by and/or include a term/duration of the transaction, a number of payment events, an amount associated with each event, conditions/additional restrictions associated with the transaction, and/or any other suitable structure defining the product.

The systems, methods, apparatuses, products, etc. discussed herein may be hosted on one or more ATMs or associated with a particular ATM. For example, the products may be generated by one or more ATMs via one or more secure instances and/or after authenticating a user identity, may be accessible via the ATM on which they were created, and/or may be created by a backend computer system and accessible via a limited number of ATMs (such as ATMs at designated geographical locations or ATMs associated with a particular financial institution). In this way, the products and improved security functionalities (e.g., microloans, card recovery controls, account security controls, etc.) may be provided on a specific ATM or tied to a particular group of ATMs.

Further, as used herein, an “ATM fraud control” may include programs, events, processes, instances, or other functionalities to detect and prevent unauthorized transactions or activity (e.g., at an ATM) or to otherwise assist a user with account security and/or continuing authorized transactions to occur associated with an account. In some embodiments, ATM fraud controls encompasses measures to detect, prevent, manage, and/or report suspicious activities at an ATM. In some embodiments, ATM fraud controls include real-time transaction monitoring to scrutinize patterns and/or spot unusual withdrawals or activities. In some embodiments, ATM fraud controls include additional authentication steps and/or instances responsive to detecting indications of fraud or receiving a request to proceed with certain transactions. Fraud controls may include one or more settings via which a user may activate, deactivate, customers, set, or otherwise manage the one or more fraud controls. As a non-limiting example, ATM fraud controls may include account security controls associated with determining whether a transaction includes one or more indications of fraud, and, in response, requiring approval of a user associated with the account before proceeding with the transaction and/or collecting data for investigative purposes. In some embodiments, improved fraud controls may include card recovery controls associated with assisting with compromised (e.g., lost or stolen) transaction media.

Further, as used herein, a “transaction medium” and/or “transaction media” may refer to an item, access code, credential, or the like used to facilitate a transaction and/or access to an account such as an account/transaction at an ATM. In some embodiments, transaction media may include debit cards, credit cards, stored value cards, or receipts with account credentials (e.g., temporary account identifiers, PIN codes, etc.) printed on them and the like. Additionally, “non-monetary media” may refer to various non-monetary items that serve a functional purpose beyond their monetary equivalent and/or that may be utilized to create, generate, or otherwise provide a user with transaction media. For example, non-monetary media may include blank transaction cards, tokens on which account credentials may be written, programmable chips, receipt paper, a message, signal, and/or notification capable of containing account access credentials and/or capable of facilitating a transaction, or the like. Non-monetary media may also refer to documents, letters, tickets, coupons, etc.

Also as used herein, an ATM, processor, computer system, or the like “identifying” an item, object, condition, event, etc. (e.g., an “element”) may include making a determination regarding the element, detecting the presence and/or absence of the element, receiving an indication of the element, or the like. For example, “identifying an account balance below a $500” may include receiving an indication that the account balance is below $500 such as receiving data indicating an account balance of $400, making a comparison between a current account balance and $500 to determine that the account balance is lower than $500, detecting a balance lower than $500, etc.

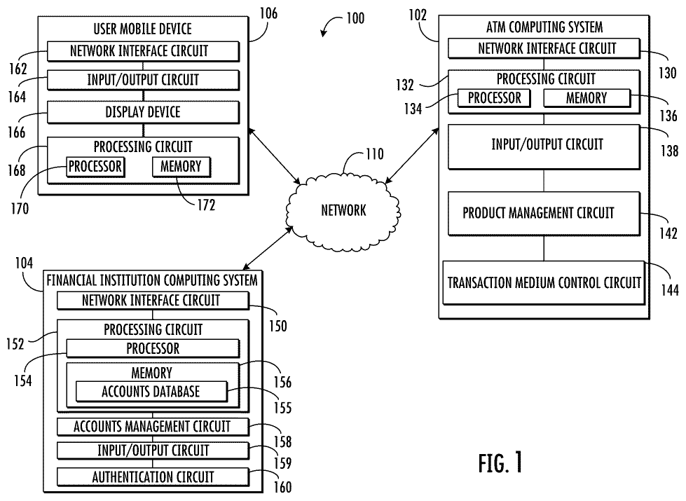

Referring to FIG. 1, an ATM system 100 including an ATM having additional secure instances, associated products, and improved security functionalities (e.g., fraud control, enhanced security, improved card recovery services, etc.) for a customer and/or non-customer is shown, according to an example embodiment. The system 100 includes an ATM system 102 and a provider institution computing system 104. In some embodiments, the system 100 may include a user mobile device 106. In some embodiments, the user mobile device 106 may include an application, program, software, or the like further configured to communicate with one or more of the ATM system 102 and/or the provider institution computing system 104 (e.g., to designate a card lost/stolen, to provide account and/or user information via a product preapproval process, to receive one or more notifications indicative of the one or more ATM fraud controls, to receive a notification indicative of a security status of the first transaction. etc.). The systems, devices, and/or components of the system 100 may be configured to communicate with each other over a network 110. The network 110 may include one or more of the Internet, cellular network, Wi-Fi®, Wi-Max, a proprietary banking network, or any other type of wired, wireless, or a combination of wired and wireless networks.

The ATM system 102 may be an ATM computing system. In some embodiments, the ATM computing system 102 includes a network interface circuit (e.g., circuit 130) that is configured to provide an interface between a user (e.g., the customer, the non-customer, an individual at the ATM, etc.), the provider institution computing system 104, and/or the user mobile device 106 over the network 110. The ATM system 102 is configured to enable various ATM transactions for a customer of the financial institution, such as allowing the customer to view account balances, purchase stamps, deposit checks, transfer funds, withdraw funds from a given account in the form of cash or other physical currency, and so on. For example, the ATM system 102 can include an ATM card slot configured to receive an ATM card inserted by a customer. The ATM system 102 may include a currency dispenser that is used to dispense currency when a user wishes to perform a physical currency withdrawal. In some embodiments, the ATM system 102 is disposed at a brick-and-mortar banking facility associated with the provider/associated financial institution. In other embodiments, the ATM system 102 is a standalone computing terminal (e.g., disposed at an unrelated retail facility, within an office building, etc.).

In addition to traditional customer transactions, the ATM system 102 of the present disclosure is configured to provide additional secure instances, associated products, and improved security functionalities to customers and non-customers (e.g., any user of the ATM). For example, the ATM system may be configured to enable transactions including products (e.g., microloans) as a response to an input associated with a first transaction, such as checking a balance, inserting a card, or requesting to deposit or withdraw funds satisfying a certain amount (e.g., a minimum amount, a maximum amount, etc.). The ATM can provide one or more instances with various products and/or transactions. The products may be generated in real-time in response to transaction inputs or based on detected account credentials. In some embodiments, the products, instances associated with the products, or the like may be accessible in response to an ATM user authenticating their identity and providing access credentials associated with a customer account. In some embodiments, the ATM system 102, the provider institution computing system 104, the user, etc. can then select, edit, customize, or otherwise obtain these products, such as in a subsequent transaction at the ATM. In some cases, the ATM system may offer products or access to more instances (e.g., instances related to pre-generated products) for users who have been pre-approved, pre-selected, or the like.

The ATM system 102 may also provide, include, and/or otherwise be interoperable with one or more ATM fraud controls including enhanced security functionalities. For example, the ATM fraud controls may include card recovery controls that permit a user access to an additional, secure transaction medium responsive to receiving an indication that a transaction medium is compromised. For example, a customer may lose an ATM card. The ATM system 102 may receive a request to provide a new ATM card associated with the customer at the ATM. The ATM system 102 may include a media aperture 181 that is configured to receive non-monetary media, physical items, and the like (e.g., ATM cards) and a storage repository having non-monetary media (e.g., blank ATM cards). In this way, the ATM system 102 may authenticate the identity of the customer, create a new temporary and/or permanent ATM card, and provide the new card to the customer. In some embodiments, the new ATM card may be set to expire but may be converted into a permanent card upon the completion of a designated transaction, confirmation of the card with a banker, etc.

In other embodiments, the ATM fraud controls may include account security controls associated with identifying one or more indications of fraud, and, in response, requiring that a user proceed with a transaction including one or more products (e.g., proceed with a microloan in place of a withdrawal), requiring approval of a user associated with the account before proceeding with the transaction, and/or collecting data for investigative purposes.

In the example shown, the ATM system 102 includes a network interface circuit 130, a processing circuit 132, an input/output circuit 138, a product management circuit 142, and a transaction medium control circuit 144.

The network interface circuit 130 is configured or structured to establish connections via the network 110 between the ATM system 102 and the provider institution computing system 104 and/or the user mobile device 106. In some embodiments, the network interface circuit 130 may be configured to establish communications via the network 110 with a third-party computing system, such as a computer system of a third-party financial institution that is not a provider of the ATM, a computer system of a credit union, a computer system of a non-bank financial institution, etc. For example, the network interface circuit 130 may enable the ATM system 102 to receive account data (e.g., an account balance) and/or one or more factors associated with the user of the ATM (e.g., a user credit score) even when the user of the ATM is a non-customer of the provider institution. The ATM may receive such information from the third-party computing system in response to authenticating an identity of the user, sending access credentials to the third-party computing system, etc. Thus, in some embodiments, the ATM is a network-connected ATM.

The processing circuit 132 includes at least one processor 134 and at least one memory 136. The memory 136 is structured to retrievably store information regarding accounts held by various users. The accounts may include a checking account held by the customer and accessible via the user mobile device 106, savings accounts, other banking accounts, accounts of charities/organizations configured to receive deposits in the form of donations from ATM users, or other suitable accounts. For instance, the memory 136 may store information related to the financial account of the user, such as authentication information (e.g., username/password combinations, personal identification numbers (PINs), device authentication tokens, security question answers, account information, balances, biometric data, etc.). Furthermore, the memory 136 may store any other information that may be encountered in the operation of an ATM having additional secure instances, associated products, and improved security functionalities or otherwise referenced herein, such as fraud control settings (e.g., user preferences regarding which security features to enable/disable) and other information comprising a user profile, transaction history, etc. The processing circuit 132 may perform or assist in performing any of the operations, steps, or methods discussed herein.

In some embodiments, the network interface circuit 130 may include one or more antennas or transceivers and associated communications hardware and logic (e.g., computer code, instructions, etc.). The network interface circuit 130 may also include program logic that is structured to allow the ATM system 102 to access and couple/connect to the network 110 to, in turn, exchange information with for example the provider institution computing system 104, the user mobile device 106, third-party computing systems, and/or other ATM systems (and potentially other systems/devices). That is, the network interface circuit 130 is coupled to the processor 134 and memory 136 and configured to enable a coupling to the network 110. The network interface circuit 130 allows for the ATM system 102 to transmit and receive data over the network 110. Accordingly, the network interface circuit 130 includes any one or more of a cellular transceiver, a wireless network transceiver, and a combination thereof. Thus, the network interface circuit 130 enables connectivity to WAN as well as LAN. Further, in some embodiments, the network interface circuit 130 includes cryptography capabilities to establish a secure or relatively secure communication session between other systems such as the provider institution computing system 104, a second ATM system, the user mobile device 106, etc. In this regard, information (e.g., account information, login information, financial data, digital objects, and/or other types of data) may be encrypted and transmitted to prevent or substantially prevent a threat of hacking or other security breach.

The input/output circuit 138 is structured to receive communications from and provide communications to other computing devices, users, and the like associated with the ATM computing system 102. The input/output circuit 138 is structured to exchange data, communications, instructions, and the like with an input/output device of the components of the system 100. In some arrangements, the input/output circuit 138 includes communication circuitry for facilitating the exchange of data, values, messages, and the like between the input/output circuit 138 and the components of the ATM computing system 102. In some arrangements, the input/output circuit 138 includes machine-readable media for facilitating the exchange of information between the input/output circuit 138 and the components of the provider institution computing system 104, the user mobile device 106, and/or the third-party computing system. In some arrangements, the input/output circuit 138 includes any combination of hardware components, communication circuitry, and machine-readable media.

In some arrangements, the I/O circuit 138 may include a network interface. The network interface may be used to establish connections with other computing devices by way of the network 110. The network interface may include program logic that facilitates connection of the ATM computing system 102 to the network 110. In some arrangements, the network interface may include any combination of a wireless network transceiver (e.g., a cellular modem, a Bluetooth transceiver, a Wi-Fi transceiver) and/or a wired network transceiver (e.g., an Ethernet transceiver). For example, the I/O circuit 138 may include an Ethernet device such as an Ethernet card and machine-readable media such as an Ethernet driver configured to facilitate connections with the network 110. In some arrangements, the network interface includes the hardware and machine-readable media sufficient to support communication over multiple channels of data communication. Further, in some arrangements, the network interface includes cryptography capabilities to establish a secure or relatively secure communication session in which data communicated over the session is encrypted.

In some arrangements, the I/O circuit 138 includes suitable input/output ports and/or uses an interconnect bus for interconnection with a local display (e.g., a liquid crystal display, a touchscreen display) and/or keyboard/mouse devices (when applicable), or the like, serving as a local user interface for programming and/or data entry, retrieval, or other user interaction purposes. As such, the input/output circuit 138 may provide an interface for the user to interact with various instances (e.g., applications and/or executables stored, hosted, or otherwise provided on the ATM computing system 102 and/or the provider institution computing system 104). For example, the input/output circuit 138 may include a keyboard, a keypad, a mouse, joystick, a touch screen, a microphone, a biometric device, a virtual reality headset, smart glasses, and the like. As another example, input/output circuit 138, may include, but is not limited to, a television monitor, a computer monitor, a printer, a facsimile, a speaker, and so on.

The product management circuit 142 is structured to manage, receive, generate, and/or otherwise enable transactions and functionalities associated with one or more products (e.g., microloans) at the ATM. The product management circuit 142 may store information indicative of one or more products hosted on, generated by, and/or accessible via the ATM. For example, the product management circuit 142 may include a database having algorithms, heuristics, look-up tables, or other structures configured to determine the balance, at least one restriction, and/or the product structure of the one or more products. Accordingly, the product management circuit 142 may receive, generate, and/or otherwise provide the one or more products (e.g., to a user of the ATM) in response to detecting inputs, data associated with the user, transactions, or the like via the I/O circuit 138.

The product management circuit 142 may also receive data used to generate, revise, validate, etc. the one or more products. In some embodiments, the product management circuit 142 communicates with the provider institution computing system 104, the user mobile device 106, or the like to monitor, update, and/or implement a product structure of the one or more products (e.g., apply a fee, indicate a balance associated with one or more products has become due, etc.). For example, the product management circuit 142 may receive factors associated with the user and/or user account data and send the user data to the processing circuit 132 and/or the provider institution computing system 104 in order to provide a product or a selection of products to the user (e.g., provide a GUI including the one or more products). The product management circuit 142 may also receive and detect one or more trigger conditions that indicate which user(s) may access instances including the one or more products. Further, the product management circuit 142 may receive data indicating pre-approved products and/or user(s) who are pre-designated to receive access to instances including one or more pre-approved, pre-generated, or otherwise pre-determined products. Prior to offering a pre-approved and/or pre-generated product, the product management circuit 142 may determine whether the product is valid and/or may update the product. For example, determining whether the product is valid may include receiving current factors and/or account data associated with a user, receiving current benchmarks associated with the one or more products (e.g., an average current interest rate), or the like. Updating the product may include editing, revising, or otherwise altering the product, such as by updating the balance and/or the at least one restriction.

The product management circuit 142 may identify and authenticate a user of the ATM by providing temporary access codes, one-time-use tokens, or other authentication credentials to ensure the security of transactions. In this way, the product management circuit 142 may communicate with the provider institution computing system 104 and/or a third-party institution computing system to verify the authenticity of the one or more products, confirm the identity of the individual at the ATM before providing the one or more products, and/or provide the appropriate product(s) associated with the user.

The transaction medium control circuit 144 is configured to manage the security, access, and operation of the ATM. For example, the transaction medium control circuit 144 may monitor the transactions, inputs/outputs, etc. of the ATM and control access to the vault 192 of the ATM. The transaction medium control circuit 144 may also identify indications of fraud, implement the one or more fraud controls, and/or enable the ATM to create or otherwise provide replacement transaction media (e.g., control the printing of a new debit card for a customer at the ATM).

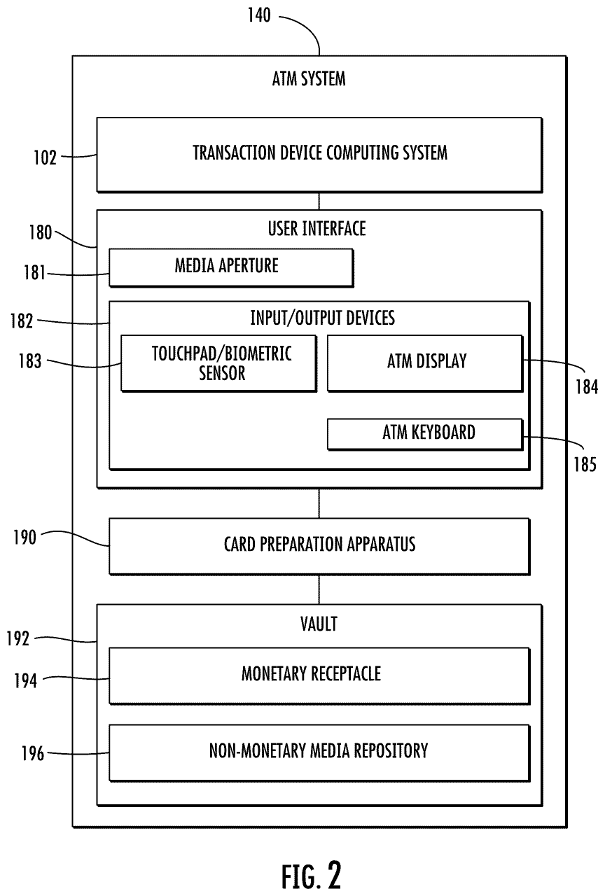

The vault 192 is a secure compartment within the ATM that may house physical currency, active/inactive transaction cards, other monetary items, and/or non-monetary media. As shown in FIG. 2, the vault 192 may include a monetary receptacle 194 for storing physical currency and other monetary items. Similarly, the vault 192 may include a storage repository 196 configured to securely receive, provide, and/or store non-monetary media such as keys, additional transaction cards, and the like. The transaction medium control circuit 144 may enable access to and from the vault 192 by customers, non-customers, and/or technicians/providers of the ATM. The transaction medium control circuit 144 may receive passcodes, commands, or other inputs or otherwise be configured to allow a technician to access the vault 192 (e.g., to resupply the ATM with physical currency or blank transaction cards) and/or may regulate customer and non-customer access to items or currency stored in the vault 192. For example, the transaction medium control circuit 144 may operate, command, or otherwise control at least one card preparation apparatus 190 that may selectively receive non-monetary media from the vault 192 during a transaction at the ATM and provide an additional transaction medium to a user of the ATM (e.g., a replacement debit card, a stored value card, etc.). In some embodiments, the transaction medium control circuit 144 may monitor the status/identity of the contents of the vault 192 and provide information regarding the vault 192 to the processing circuit 132 and/or the provider institution computing system 104. For example, the transaction medium control circuit 144 may track an amount of non-monetary media present in the storage repository 196, an identity of a user requesting an additional transaction media, transaction patterns associated with one or more users, active/inactive fraud controls associated with a customer account, and/or a percentage of available storage space within the vault 192, among other information.

The provider institution computing system 104 is a computing system associated with an entity or provider institution, such as a financial institution, capable of maintaining user accounts (e.g., ATM card accounts, savings accounts, debit accounts, etc.) and databases of user information. In the example shown, the provider institution is a financial institution. The financial institution may include commercial or private banks, credit unions, investment brokerages, or other financial institutions. The provider institution computing system 104 may maintain a plurality of user accounts having various information. For example, user account data may include a balance, an account age, an account status, a standing with the institution, an account identifier (such as an account number, the type of account, etc.), and/or previous account activity (e.g., previous deposits, withdrawals, overdraws, etc.). In the example shown, the provider institution is an issuer of ATM cards (e.g., a debit card) for customers of the financial institution to use at the ATM. Additionally, the provider institution, via the system 100 and ATM computing system 102, provides products and enhanced fraud controls for customers and/or non-customers at the ATM as discussed herein. For example, the provider institution may provide, choose one or more features of, manage, pre-approve, etc. one or more products associated with one or more specific ATMs and/or users. Additionally, the provider institution may provide ATMs having storage repositories and hardware capable of authenticating a user, storing at least one non-monetary media, and converting the non-monetary media into a transaction medium for a user at the ATM.

The provider institution may also designate trigger conditions, pre-requisites, transaction patterns, associated restrictions, or other features associated with the products and/or enhanced fraud controls. For example, one or more products may be presented to only a subset of customers at the ATM who meet predesignated requirements or who have performed certain transaction(s) and/or transaction pattern(s) within a designated time frame. As an example, one product may be offered to customers who have an account balance that satisfies a threshold, such as an account balance below a monetary amount. In other examples, one or more products may be directed to customers at the ATM who have a number of overdraft events within a period of time that satisfies an overdraft threshold. In still further embodiments, one or more products may be provided to a user who meets a predefined transaction pattern (e.g., a user who has acquired a house within the last six-months, etc.). In this way, the provider institution may direct one or more products to one or more intended individuals at the ATM who may be more inclined to utilize and/or more likely to accept the one or more products.

Also, in the example shown, the provider institution computing system 104 is structured as a backend computing system that may comprise one or more servers. The financial institution may provide or support the ATM computing system 102 (e.g., manufacture or cause manufacturing of the ATM computing system 102 and ATM, enable access to accounts/products maintained by the provider institution computing system 104 via the ATM computing system 102, etc.). In some embodiments, the provider institution computing system 104 is structured to permit, enable, facilitate, manage, process, and allow ATM transactions via communication with the user mobile device 106 and/or the ATM system 102. The provider institution computing system 104 may store information relating to a user account as it may be used to execute an ATM transaction via the ATM computing system 102. For example, the provider institution computing system 104 may store information relating to checking accounts, savings accounts, withdrawals of funds, deposits of funds, the one or more products provided at the ATMs, storage/exchanges of non-monetary media, and so on. In this way, the provider institution computing system 104 may store or receive information from the product management circuit 142 and/or the transaction medium control circuit 144 of the ATM relating to use of the ATM computing system 102. Examples of information relating to the product management circuit 142 and/or the transaction medium control circuit 144 include data, access codes, identifiers associated with the one or more products and/or the non-monetary physical media stored within an ATM or exchanged at an ATM, and the like. As will be appreciated, the level of functionality that resides on the provider institution computing system 104 as opposed to the ATM computing system 102 may vary depending on the implementation of this disclosure. As shown, the provider institution computing system 104 includes a network interface circuit 150, a processing circuit 152, an accounts database 155, an accounts management circuit 158, an input/output circuit 159, and an authentication circuit 160.

The network interface circuit 150 is structured to couple to the network 110 to enable communications with the user mobile device 106 and/or the ATM computing system 102, among potentially other systems and devices. In some embodiments, the network interface circuit 150 includes programming and/or hardware-based components that connect the provider institution computing system 104 to the network 110. The network interface circuit 150 may be coupled to the processing circuit 152 to enable the processing circuit 152 to receive and transmit messages, data, and information via the network 110. In some embodiments, the network interface circuit 150 may include one or more antennas or transceivers and associated communications hardware and logic (e.g., computer code, instructions, etc.). The network interface circuit 150 may also include program logic that is structured to allow the provider institution computing system 104 to access and couple/connect to the network 110 to, in turn, exchange information with for example the user mobile device 106 and/or the ATM computing system 102 (and potentially other systems/devices). The network interface circuit 150 allows for the provider institution computing system 104 to transmit and receive data over the network 110. Accordingly, the network interface circuit 150 includes any one or more of a cellular transceiver (e.g., CDMA, GSM, LTE, etc.), a wireless network transceiver (e.g., 802.11X, ZigBee, WI-FI, Internet, etc.), and a combination thereof (e.g., both a cellular transceiver and a wireless transceiver). Thus, the network interface circuit 150 enables connectivity to WAN as well as LAN (e.g., Bluetooth, near field communication (NFC), etc. transceivers). Further, in some embodiments, the network interface circuit 150 includes cryptography capabilities to establish a secure or relatively secure communication session between other systems such as the user mobile device 106, the ATM computing system 102, etc. In this regard, information (e.g., account information, login information, financial data, digital objects, and/or other types of data) may be encrypted and transmitted to prevent or substantially prevent a threat of hacking or other security breach. To further support features of or interaction with the provider institution computing system 104, the network interface circuit 150 may provide a relatively high-speed link to the network 110.

The at least one processing circuit 152 is shown to include at least one processor 154 and at least one memory 156 and may be communicably connected to the network interface circuit 150, the accounts management circuit 158, the input/output circuit 159, and the authentication circuit 160. The memory 156 includes one or more memory devices (e.g., RAM, NVRAM, ROM, Flash Memory, hard disk storage) that store data and/or computer code for facilitating the various processes described herein. That is, in operation and use, the memory 156 stores at least portions of instructions and data for execution by the processor 154 to perform various operations. The memory 156 may be or include tangible, non-transient volatile memory and/or non-volatile memory. The processor 154 may be implemented as one or more processors, application specific integrated circuits (ASIC), one or more field programmable gate arrays (FPGAs), a digital signal processor (DSP), a group of processing components, or other suitable electronic processing components. The processing circuit 152 may perform or assist in performing any of the operations, steps, or methods discussed herein.

The memory 156 may include an accounts database 155. The accounts database 155 is structured to retrievably store information regarding accounts held by customers and non-customers of the provider institution. For example, the accounts database 155 may store information regarding a debit account held by a customer of the financial institution. The accounts database 155 may also store information regarding a product accepted by a customer of the financial institution and provided via the ATM computing system 102 and/or the user mobile device 106. For instance, the accounts database 155 may store information related to the user, the user mobile device 106, and/or the ATM computing system 102 such as authentication information (e.g., username/password combinations, device authentication tokens, security question answers, OTPs, PINs, biometric information, etc.), user information (e.g., name, date of birth, etc.), account information (e.g., account number, balance information, expiration date, etc.), product information (e.g., product balance, at least one restriction associated with the product, ATMs permitted to access/host the instances including the product, etc.), identifiers of ATM storage repositories that are occupied/unoccupied, logs of temporary/permanent cards provided from the ATM storage repositories, and so on. The accounts database 155 may store within the user's client account all or mostly all of the items that the user has registered with the provider institution computing system 104, including customer and/or non-customer data (such as user profiles with customer/non-customer personal information, account/banking channel numbers, bill and payment histories, communications sent and received from the customer/non-customer, etc.). In various embodiments, the accounts database 155 is structured as one or more remote data-storage facilities (e.g., cloud servers). In some embodiments, the accounts database may be located in whole or in part on the ATM computing system 102.

The accounts management circuit 158 is structured to manage the accounts and other information of various users, including maintaining and handling transaction processing for one or more products provided to and/or accepted by the users. Accordingly, the accounts management circuit 158 is configured to process payments made from an account of the user held at the financial institution associated with the provider institution computing system 104. Further, the accounts management circuit 158 is configured to process deposits/withdrawals that a customer and/or non-customer makes into/from the ATM computing system 102 and/or the user mobile device 106. In some embodiments, the accounts management circuit 158 is further configured to interface with the ATM product management circuit 142 such that the accounts management circuit 158 provides interfaces, displays, and associated content to enable access to the one or more products provided via the ATM computing system 102 associated with the provider institution computing system 104. In further embodiments, the accounts management circuit 158 is further configured to interface with ATM transaction medium control circuit 144 such that the accounts management circuit 158 provides interfaces, displays, and associated content to enable customers and/or non-customers to store/retrieve non-monetary physical media within an ATM or exchange/receive non-monetary media at the ATM for currency, account credits, or the like. In still further embodiments, the accounts management circuit 158 is configured to monitor the transaction patters, inputs, characteristics of one or more users, and/or selected fraud controls at one or more designated ATMs, one or more ATMs within a designated geographic region, etc.

Like the input/output circuit 138, the input/output circuit 159 is structured to receive communications from and provide communications to other computing devices, users, and the like associated with the provider institution computing system 104. The input/output circuit 159 is structured to exchange data, communications, instructions, and the like with an input/output device of the components of the system 100. In some arrangements, the input/output circuit 159 includes any combination of hardware components, communication circuitry, and machine-readable media for facilitating the exchange of data, values, messages, and the like between the input/output circuit 159 and the components of the provider institution computing system 104 and/or the system 100. In some arrangements, the I/O circuit 159 may include a network interface. The network interface may be used to establish connections with other computing devices by way of the network 110. In some arrangements, the network interface includes the hardware and machine-readable media sufficient to support communication over multiple channels of data communication. Further, in some arrangements, the network interface includes cryptography capabilities to establish a secure or relatively secure communication session in which data communicated over the session is encrypted. In some arrangements, the I/O circuit 159 includes suitable input/output ports and/or uses an interconnect bus for interconnection with a local display (e.g., a liquid crystal display, a touchscreen display) and/or keyboard/mouse devices (when applicable), or the like, serving as a local user interface for programming and/or data entry, retrieval, or other user interaction purposes. As such, the input/output circuit 159 may provide an interface for the user to interact with various applications and/or executables stored on the provider institution computing system 104.

The authentication circuit 160 is configured to verify that individuals attempting to access the ATM to perform transactions are legitimate account holders or are legitimate non-customers who may be provided access to instances of the ATM including the one or more products. In this way, the authentication circuit 160 is configured to prevent unauthorized access to customer accounts (e.g., checking accounts, saving accounts, etc.) and non-customer accounts (e.g., non-customer banking channels). The authentication circuit 160 may receive input data from the ATM such as account numbers, account identifiers, username and password combinations, passcodes, biometric data and the like related to the identity of the individual utilizing the ATM. The authentication circuit 160 may compare data received from an ATM user with information stored in the accounts database 155 of the provider institution computing system 104. The authentication circuit 160 may also permit access to specific ATM functionalities based on respective user account data, privileges, and status as a customer/non-customer. For example, the authentication circuit 160 may permit a customer to withdraw cash, check an account balance, perform other authorized transactions, or receive access to secure instances including pre-approved products. The authentication circuit 160 may direct a non-customer to open an account or to provide additional identification before providing access to the one or more products. The authentication circuit 160 may also store or track information about user access, authentication attempts, and transaction details associated with one or more ATMs (e.g., whether a user declines one or more products associated with a designated ATM, whether a customer attempts to access the one or more products at an undesignated ATM, etc.). Additionally, the authentication circuit 160 may obtain information from various sources (e.g., by sending a text to the user mobile device 106 with a verification code, by receiving inputs from the ATM, etc.) to authenticate a new user of the ATM system 102.

The authentication circuit 160 may also generate, send, and/or verify authentication credentials associated with transactions involving the one or more products and/or requests to generate additional transaction media from the non-monetary media at one or more ATMs. For example, an ATM may receive an indication that a card is compromised and/or a request for a new card from the card preparation apparatus and/or storage repository 196 of the ATM. The authentication circuit 160 may generate a passcode, a username and password combination, a quick access (QR) code, a token, or other suitable authentication credentials specific to the non-monetary media and/or the transaction card request. In other embodiments, the authentication circuit may initiate a near field communication (NFC) between the ATM and a user device 106. The authentication circuit 160 may require the ATM and the user device 106 be within a proximity of each other (e.g., 10 cm, 20 cm, etc.) in order to process an NFC tap of a token associated with the ATM to the user device 106. In this way, the user who requested a replacement card may subsequently present the authentication credentials (e.g., passcode, QR code, subsequent NFC communication, etc.) to the ATM to retrieve the additional transaction media.

The user mobile device 106 may include a mobile device associated with an ATM user. The user may be one or more individuals (e.g., a customer, a non-customer), business representatives, government representatives, and so on. The user mobile device 106 is structured to exchange data over the network 110, execute software applications, access websites, generate graphical user interfaces, and perform other operations described herein. The user mobile device 106 may include one or more of a smartphone or other cellular device, a wearable computing device (e.g., a watch or bracelet, etc.), a tablet, a portable gaming device, a laptop, and other portable computing devices. In some embodiments, the user device 106 may be a stationary computing device, such as a desktop computer. The user mobile device 106 includes a network interface circuit 162, an input/output circuit 164, a display device 166, and a processing circuit 168. The network interface circuit 162 is configured or structured to establish connections via the network 110 between the user mobile device 106, the ATM computing system 102, and the provider institution computing system 104 similar to the network interface circuits discussed above. The processing circuit 168 includes a processor 170 and a memory 172. The processing circuit 168 may be communicably coupled to the ATM system 102 and/or the provider institution computing system 104.

The input/output circuit 164 is structured to receive communications from and provide communications to the user of the user mobile device 106 associated with a transaction at the ATM. The input/output circuit 121 includes hardware and associated logic (e.g., instructions, computer code, etc.) to enable the user mobile device 106 to exchange information with a user and other devices (e.g., the provider institution computing system 104, the ATM computing system 102) that may interact with the user mobile device 106. The input/output circuit 164 may provide information to access, obtain, update, or otherwise interact with the one or more products on the ATM computing system 102. The information may also include authentication credentials including a passcode, key, command, or the like to retrieve replacement transaction media via the ATM.

The input/output circuit 164 may include any combination of hardware components, for example, a mechanical keyboard, a touchscreen, a microphone, a camera, a fingerprint scanner, a device that is able to be coupled to the user mobile device 106 via a connection (e.g., USB, serial cable, Ethernet cable, etc.), and so on. The output aspect of the input/output circuit 164 allows the user to receive information from the user mobile device 106, and may include, for example, a digital display, a speaker, illuminating icons, light emitting diodes (“LEDs”), and so on. Thus, the input/output circuit 164 may include systems, components, devices, and apparatuses that serve both input and output functions; only input functions; and/or only output functions. The input/output circuit 164 may include communication circuitry for facilitating the exchange of data, values, messages, and the like between an input and/or output device and the components of the user mobile device 106.

In some embodiments, the display device 166 may be a screen, such as a touchscreen or another display device. The user mobile device 106 may communicate information to the user via the display device 166 and/or to receive communications from the user (e.g., through a keyboard provided on the display device 166). In some embodiments, the display device 166 may be a component of the input/output circuit 164, as described above.

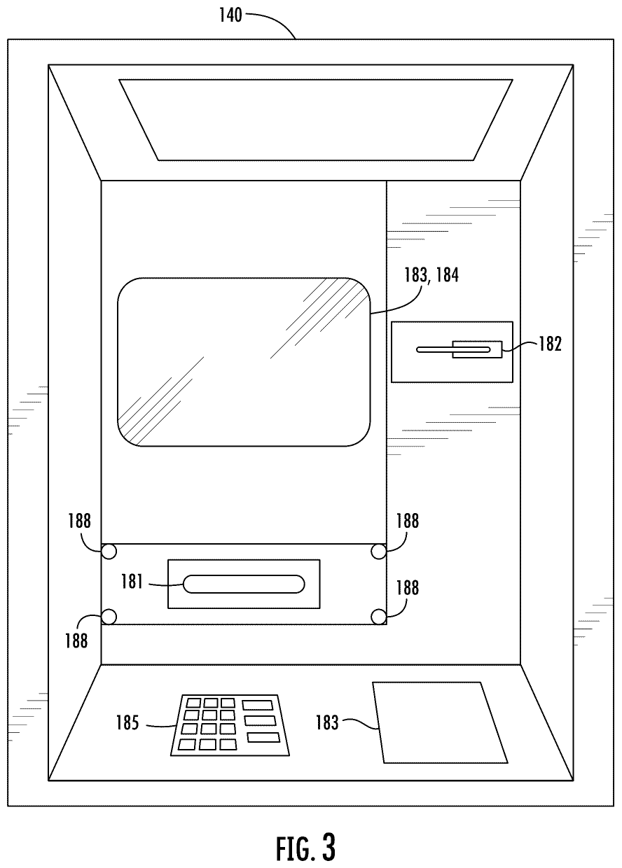

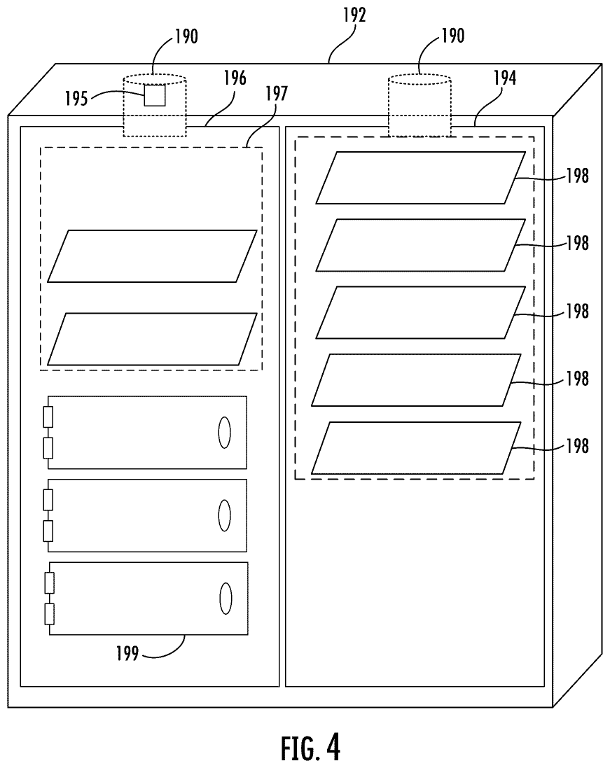

Turning to FIG. 2, a block diagram illustrating an example transaction device 140 (e.g., an ATM) is shown, according to an embodiment. The transaction device 140 may include an ATM system (for example, as depicted in FIGS. 3-4), a standalone terminal/kiosk, or another suitable computing system capable of performing the transactions disclosed herein. The transaction device 140 includes the transaction device computing system (e.g., the ATM system 102) shown in FIG. 1. The transaction device 140 may also comprise a user interface 180, a card preparation apparatus 190, and a vault 192.

The user interface 180 may include at least one media aperture 181 and input/output devices 182. The media aperture 181 is configured to receive non-monetary media, for example, an ATM card. Additionally, the media aperture 181 may retrieve non-monetary media from the storage repository 196 that has been converted into a transaction medium via the card preparation apparatus 190. In this way, the media aperture 181 may provide a transaction medium (such as a temporary or replacement ATM card, a stored value card, a receipt including temporary account access credentials, etc.) to a user of the transaction device 140. In still further embodiments, the media aperture 181 may be configured to allow access to and from the storage repository 196. For example, the media aperture 181 may include a slot, a door, a drop-box, a conveyor, an arm and movable appendage, one or more rollers, a window configured to open and close, or another suitable device for receiving or dispensing non-monetary media converted into a transaction media and/or refilling the repository with non-monetary media. In other arrangements, each media aperture 181 may be structured to receive and/or dispense a specific type of non-monetary media (e.g., replacement cards, tickets/coupons/receipts containing temporary access credentials, stored value cards, etc.). For example, a media aperture 181 comprising a receipt dispenser may be dedicated to providing temporary replacement credentials via a printed receipt, while larger a media aperture 181 comprising a door and lock, a card slot, or the like may be dedicated to providing permanent replacement ATM cards with account numbers, card verification value (CVV) numbers, identifiers, and the like printed on the card via the ATM (e.g., via the card preparation apparatus 190). In some arrangements, the media aperture 181 is operable between an open position and a closed position and/or a locked state and an unlocked state. For example, the media aperture 181 may be operable to the open position when receiving or dispensing transaction media and operable to the closed position when the transaction device 140 is inactive/storing the non-monetary media.

The user interface 180 may also include one or more input/output devices 182. The input/output devices 182 are configured to allow the user to interact with the transaction device 140 by submitting user data, making selections on the transaction device, depositing monetary items and/or non-monetary media, withdrawing monetary items and/or non-monetary media, receiving information from the transaction device 140, authenticating and providing security information to transaction device 140, and otherwise enabling a user to operate/navigate the functionalities of the transaction device 140. For example, the input/output devices 182 may include a card reader structured to receive an input from a transaction card (e.g., an ATM card, a debit card, a gift card) and/or a security card (e.g., an identification card). The input devices may be configured to read a RFID signal, a magnetic strip, a security chip, and/or any other input signal. In some arrangements, the I/O devices 182 may include a keypad, keyboard, touchscreen, speaker, microphone, or other typing device structured to receive a user input including an alphanumeric input, or other touch input. In some arrangements, the I/O devices 186 includes a biometric sensor structured to receive a biometric from a user such as a fingerprint scan, an eye scan, a face scan, a photo, a voice sample, or the like. The I/O devices 182 may further include a screen, a display, a device (e.g., a user device 106) communicatively coupled to the transaction device 140, or other suitable devices. The ATM system 102 may be configured to track, monitor, and/or associate patterns based on an individual's interaction with the user interface 180. For example, the ATM system 102 may, via the transaction medium control circuit 144, detect a cadence of button presses, a dominant hand used during the transaction, a color car present at the ATM during the transaction, an octave/pitch/tone of voice of an individual, or other suitable patterns and/or identifiers.

The vault 192 may include a secure housing defining an area within the transaction device 140 that may include a monetary receptacle 194 and the storage repository 196. The vault 192 may divided into one or more compartments that define the monetary receptacle 194 and/or the storage repository 196. In some embodiments, the monetary receptacle 194 and the storage repository may be located in the same compartment of the vault 192 or otherwise share space within the transaction device 140. The monetary receptacle may be configured to receive and sort physical currency by denomination, receive, read, collect, and/or otherwise process checks or other monetary items. The storage repository 196 may be configured to receive and/or store any type of suitable non-monetary media, for example, for the card preparation apparatus to convert into a replacement transaction medium for a customer. The storage repository 196 may be accessible via one or more media apertures 181. For example, the storage repository 196 may include a door and be configured in a manner similar to a safety deposit box integrated into the transaction device 140. In other embodiments, the storage repository 196 may include one or more internal compartments configured to receive and dispense non-monetary media. For example, the storage repository 196 may include one or more chambers, racks, cartridges, shelves, etc. for storing blank ATM cards, tokens, tickets, coupons, documents, and the like.

The card preparation apparatus 190 may be configured to securely transport currency items, non-monetary media, and/or transaction media to/from the monetary receptacle 194 and the storage repository 196. In some embodiments, the card preparation apparatus 190 may be configured to generate, create, or otherwise provide a replacement/additional transaction medium to a user responsive to receiving an indication that the previous transaction medium of the user is compromised. For example, the card preparation apparatus 190 may include a lift, arm, tube, conveyor, printer, embossing machine, magnetic strip encoder, chip programmer/encoder, hologram applicator, quality control and/or transaction medium testing equipment, or other devices operable to receive currency and/or non-monetary media, deliver the currency and/or non-monetary media to the vault 192, retrieve the currency and/or non-monetary media from the vault 192, provide the currency, convert the non-monetary media to a transaction medium, and/or provide the transaction medium to the user of the transaction device 140.

Turning to FIG. 3, a front elevated view of a transaction device 140 is illustrated, according to an example arrangement. As shown in FIG. 3, the transaction device 140 includes at least one media aperture 181, a display screen 184 (e.g., an input/output device 182 which may include touchpad 183 functionality), and one or more other input/output devices 182. As shown in FIG. 3, the input/output devices 182 may include a card reader, a keyboard or keypad 185, a touch screen, biometric input, a QR reader 186, a camera, a microphone, and the like. Various other input output devices 182 may also be included such as a currency input/dispenser, a receipt dispenser, etc.

The transaction device 140 also includes the at least one media aperture 181. In some arrangements, the transaction device 140 also includes one or more mounting devices 188 configured to couple the media aperture 181 or a component associated with the media aperture 181 (e.g., a housing, a chute/panel leading to the vault 192, etc.) to the transaction device 140. In some arrangements, the transaction device 140 may include more than one media aperture 181. For example, as shown in FIGS. 3 and 4, the media apertures 181 may include a slot, input tray, drawer, or other suitable device on an elevated portion of the transaction device 140 and may include one or more doors 199 configured to selectively allow access to the storage repository 196 on a lower portion of the transaction device 140.

The display screen 184 is a display output structured to display a user interface. The user interface (UI) may include a UI structured to facilitate a transaction. The UI may be displayed during transaction operations performed by the transaction device 140. The UI may also include a service mode UI structured to facilitate a service operation (e.g., may allow a technician or provider to access the monetary receptable and/or storage compartment to conduct maintenance, etc.). The UI may include any number of interactive elements or icons for facilitating the services for providing one or more products (e.g., via secure additional instances), implementing the one or more fraud controls, or otherwise implementing the systems, methods, and the like described herein.

The I/O devices 182, 185, 186 may include at least one I/O device for facilitating an operation (e.g., a transactional operation and/or a service mode operation) at the transaction device 140. The one or more mounting devices 188 may include any combination of fasteners, pins, magnets, snap fit devices, holes, and/or receptacles for coupling the media aperture 181 to the transaction device 140.

FIG. 4 is an internal view of a lower portion of the transaction device 140 of FIG. 3, according to an example arrangement. As shown in FIG. 4, the transaction device 140 includes a vault 192 defined in the lower portion. The vault 192 includes, in this example, two compartments, one configured as a monetary receptacle 194, and the other configured as a storage repository 196 for non-monetary media. The monetary receptacle 194 may include one or more cassette slots 198 for receiving physical currency, banknotes, and the like. In some arrangements, the one or more card preparation(s) 190 may include a portion configured coupled to the monetary receptacle 194 and/or the storage repository 196. Accordingly, the card preparation apparatus 190 may, in some embodiments, transport physical currency and the like during a transaction. In some embodiments, a transport apparatus separate from the card preparation apparatus 190 may be dedicated to transporting physical currency, banknotes, and the like.

As shown in FIG. 4, the storage repository 196 may include multiple compartments configured to store respective non-monetary media. For example, the example storage repository 196 of FIG. 4 includes three doors 199 (e.g., media apertures 181) that may each lead to a separate compartment configured to securely store non-monetary media for a customer or non-customer. In this way, the compartments including doors 199 may be used to retrievably store and/or return non-monetary media and/or transaction media. For example, a printer, magnetic stripe encoder, or the like may convert a ticket, token, etc. into a stored value card, ticket including account access credentials for a one-time use transaction (e.g., a temporary replacement transaction medium) or the like. Once created or otherwise converted, the card preparation apparatus 190 may drop, locate, move, etc. the replacement transaction medium into the compartment and unlock the door 199. Further, in some embodiments, customers may receive a benefit, such as a monetary award, for returning spent stored value cards to the compartment, which may be wiped, recycled, re-used, etc.

Also shown in FIG. 4, the storage repository 196 may also define an area 197 accessible only via the card preparation apparatus 190. In this way, the card preparation apparatus 190 may prevent users from reaching inside or otherwise gaining direct access to the area 197 of the storage repository 196. For example, the area 197 may include a compartment configured to irretrievably receive and store non-monetary media until accessed by a technician or provider representative. For example, the technician may refill a blank card repository in the area 197, which may remain inaccessible (e.g., only converted transaction cards are removed, no new blank cards are received) until the technician or provider representative later returns to restock the area 197. In some embodiments, the storage repository 196 may be configured to communicate to the processing circuit 132 and/or the provider institution computing system 104 regarding the amount of space available within the storage repository 196. For example, sensors may detect the presence of one or more objects in the storage repository, a weight of objects in the storage repository, or the like, and correlate the weight or number of objects with a percentage of capacity occupied by non-monetary media. The processing circuit 132 may then send an alert to the provider institution indicating that a supply operation should occur to resupply the non-monetary media.

Further, in some embodiments, the transaction device 140 may include one or more sensors 195. The sensors 195 may be configured to collect data indicative of an identity, status, validity, or the like of the at least one non-monetary media and/or transaction medium. For example, the sensors may include cameras, RFID readers, QR scanners, barcode scanners, imaging and vision systems, or other sensors configured to collect data indicative of the identify of the non-monetary media, operation of the transaction media, etc. The data may include a shape, color, weight, size, product number, electrical reading, product code, photograph, account connectivity, chip reading capability, or other information to confirm the identity/operability of the non-monetary media and/or transaction media.

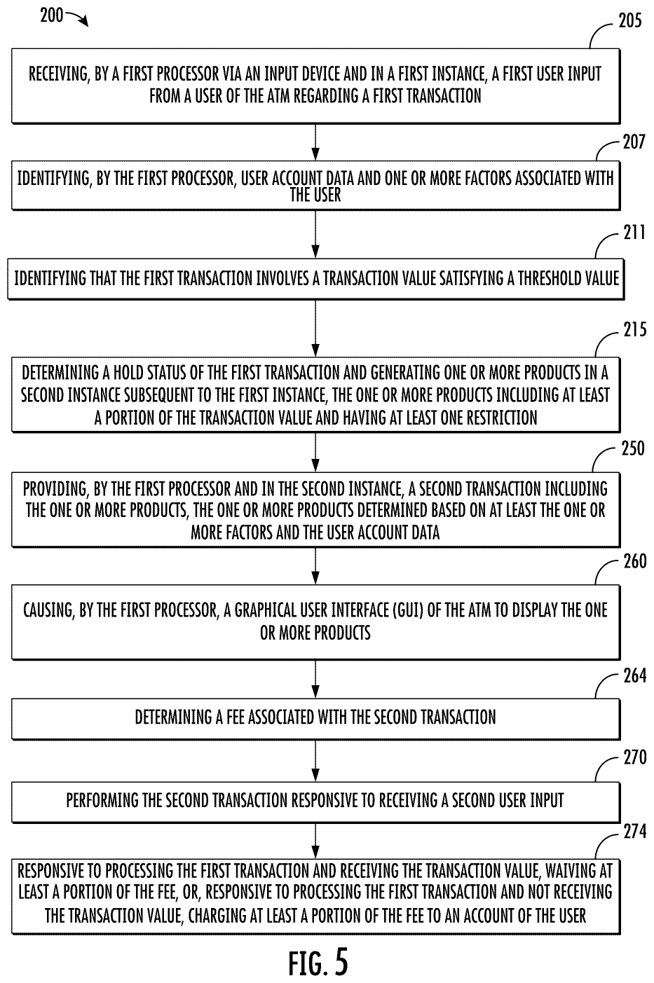

Referring now to FIG. 5, an example method 200 for providing additional secure instances, associated products, and improved security functionalities via an ATM is shown, according to an example embodiment. As described in greater detail below and in one embodiment, the transaction device 140 may receive, by a first processor (e.g., the processing circuit 132) via an input device and in a first instance, a first user input from a user of the ATM regarding a first transaction. For example, the first input may include a user selecting a button, a touch screen prompt, an ATM card insertion, or other identifier to begin a transaction associated with the ATM. Such transactions may include deposits, withdrawals, processing checks, or any other suitable transaction. Accordingly, the transaction device 140 may launch an application, begin a program, or otherwise function to provide a first instance for the user. Because method 200 may be implemented with the system and components shown in FIGS. 1-4, reference may be made to one or more components of FIGS. 1-4 in explaining method 200. Additionally, the shown steps may be optional, repeated, separated by additional optional steps or intervening steps, or expanded upon to include additional actions/functionalities. For example, the steps shown in FIGS. 5-7 for the example embodiments of the method 200 may be combined, exchanged, or otherwise incorporated into various methods having any and/or all of the steps and functionalities described herein. All such iterations of the operating process as would be apparent to a person of ordinary skill in the art are contemplated within this disclosure.

At step 205, the transaction device 140, in a first instance, receives, via the input device, the first user input from the user of the ATM regarding a first transaction. As discussed above, the input device may include a keyboard 185, a touchpad 183, or any other suitable device. The first user input may include a selection of a transaction involving a user account, a user ATM card, or the like and may be received via a button press, a keypad selection, a wireless command, or the like. For example, the ATM may display multiple potential selections or prompts such as “insert card,” “donate funds,” or “store belongings.” Prompts and/or selections such as “store belongings” may identify transactions involving non-monetary media. Other suitable first user inputs include button presses identifying item rental services (e.g., rent shoes, rent keys, rent binoculars, rent umbrellas, etc.) and selections allowing for item exchanges (e.g., exchange phone for cash, exchange currency for envelope/stamps, or the like). In other embodiments, the first user input may be received by the ATM from a user device 106. For example, the ATM may receive a communication from a user device 106 requesting that the ATM launch a program/process associated with a transaction involving monetary and/or non-monetary media.

At step 207, responsive to receiving the first user input, the transaction device 140 may receive, by the processing circuit 132, at least one of user account data and/or one or more factors associated with the user. As discussed above, the user account data may include an account balance, an account age, an account status, a standing with the provider institution, an account identifier (such as an account number, the type of account, etc.), and/or previous account activity (e.g., previous deposits, withdrawals, overdraws, etc.). In some embodiments, the one or more factors associated with the user may include a user credit score, a user income (e.g., individual income, household income, etc.), a user transaction history, and/or information associated with the first transaction (e.g., a first transaction time, location, amount, etc.). The user transaction history may include items previously purchased by the user, investments made by the user, purchasing patterns made by the user, or other suitable past transactions. At this step, the transaction device 140 may identify the user account data and/or one or more factors associated with the user from the provider institution computing system 104, the memory 136 of the ATM, via the network 110, from the user device 106, from a chip read, ATM card, stored value card, or any other suitable source. In some embodiments, after receiving the first user input, the transaction device 140 will prompt a user (e.g., via the display 184) to input additional user data such as an email address, an address, a social security number, etc. As discussed herein, at least one of the user account data, one or more factors associated with the user, and/or additional user information may be utilized when selecting, generating, creating, revising, and/or otherwise providing the one or more products to the user via the ATM.

In some embodiments, at step 211, responsive to receiving the first user input, the transaction device 140, identifies, detects, and/or otherwise receives an indication, by the processing circuit 132, that the first transaction involves a transaction value satisfying a transaction threshold. The first transaction may involve a transaction value above the transaction threshold. For example, the transaction threshold may be a deposit/withdraw maximum allowed at the ATM and/or by the provider institution. Such transactions may traditionally be associated with a delay, hold, or the like (e.g., to confirm that the user has access to sufficient funds, to avoid erroneously conducting a large transaction, etc.). A user may attempt to withdraw/deposit, as an illustration, $7,500 in order to purchase a car, to close on a home, or the like. The ATM may detect the transaction value $7,500 above the transaction threshold (e.g., $500, $1,000, etc.) and provide the user with the opportunity to proceed with the transaction via accepting one or more products offered at the ATM such as one or more microloans, alternative transactions, advances, or the like. In some embodiments, the first transaction may involve a transaction value below the transaction threshold. For example, the transaction value may be below a product cap under which the ATM may offer the one or more products (e.g., falling below an upper threshold such as $50,000 may allow the presentation of the one or more products, but the one or more products may not be offered for transaction values above the upper threshold such as $50,000 as a security measure, or the like).

At step 215, the transaction device 140 may determining a hold status of the first transaction. The hold status may include detecting a hold associated with the first transaction, detecting that the transaction value of the first transaction will result in a hold and/or a delay, receiving an indication that the first transaction is unauthorized, or the like. Responsive to determining that the transaction is associated with a hold or delay, the transaction device 140 may prompt the user to select one or more products (e.g., microloans) in order to proceed with the transaction. In some embodiments, the transaction device 140 may not determine a hold status associated with the transaction.

Accordingly, at step 215, after detecting that the transaction value satisfies the transaction threshold, the transaction device 140 may generate the one or more products in a second instance subsequent to the first instance such that each of the one or more products includes at least a portion of the transaction value and has at least one restriction. The ATM may generate the one or more products in real time in the second instance and responsive to the information received during the first instance, associated with the user, or the like. In some embodiments, the ATM may receive user inputs to customize, adjust the balance, product structure, etc. of the one or more products, and generate the products considering the received user selections. In this way, in place of and/or in addition to the first transaction, the ATM may provide a second transaction and the one or more products to avoid the imposition of a hold, to provide flexibility to the user, and to increase the security of the transaction by requiring additional authentication and identify verification steps (e.g., to access the second instance).

For example, using the example above, an individual may attempt to cash a $5,000 check at the ATM of the provider institution. The ATM may receive a first user input from the individual regarding the first transaction. The first user input may include receipt of a command to withdraw/deposit funds, the starting of a program to cash the check, the request for $5,000, and/or the like. The ATM may also receive user inputs such as a PIN code, user identifier, a routing/account number indicative of user account data and/or one or more factors associated with the user. Accordingly, the ATM may access the user account data to receive indications of a current account balance, an account age, a number of previous attempted transactions, a user credit score, a user income, or the like. In some embodiments, the transaction threshold may be a fixed value (e.g., for transactions involving more than $1,000, provide the user with one or more products). In some embodiments, the transaction device 140 and/or the method 200 may include determining a transaction threshold based on at least one of the user account data, the one or more factors, or the like. For example, the ATM, via the product management circuit 142, may include one or more algorithms, heuristics, etc. that may receive an indication to raise and/or lower the transaction threshold. A large account balance, a low number of overdraw events, a long account age, etc. may indicate that the one or more products is not needed, and that the user may proceed with the first transaction (e.g., that the transaction threshold is a relatively high value such as $10,000). However, a small account balance, a large number of overdraw events, and a short account history may indicate that the transaction threshold is a lower value such as $1,000, $5,000, etc. Accordingly, the ATM may detect that the transaction value exceeds the transaction threshold and generate the one or more products associated with the first transaction. The products may include a first microloan having a balance of $4,000, a designated restriction, and a product structure including a term of six months. The products may include a second microloan having a balance of the entire $5,000, a larger restriction, and a longer duration of the product structure. The products may include an alternative advance program providing smaller transactions at set intervals, or other suitable products for the second transaction.

At step 250, the transaction device 140 may provide, by the first processor and in the second instance, a second transaction including the one or more products. As discussed above, the one or more products may be determined based on at least the one or more factors and the user account data. For example, the ATM may display a notification indicating that a $5,000 withdrawal, check deposit, or the like is above a permissible value. The ATM may provide an indication to cancel the transaction or an indication to proceed, via the second instance and the second transaction, with the one or more products. In this way, the user may select the one or more products as an alternative or in addition to the first transaction, thereby avoiding delay, holds, and providing the requested funds (e.g., increasing user account flexibility).

Additionally, the second instance may be provided behind and/or otherwise require heightened security and/or authentication procedures before the user may proceed or complete the second transaction. For example, the method 200 may include establishing, by the ATM, a wireless connection between the ATM and the provider institution computing system 104, responsive to receiving the first user input. The wireless connection may enable the provider institution to authenticate the user and/or the user device associated with the first transaction and/or the second transaction. For example, after receiving the first input, the ATM may present a prompt requesting that one or more user devices 106 and/or users be authenticated. Accordingly, the method 200 may include receiving, by the ATM, a user input comprising user data indicative of a user device. The user data may include a phone number, an IP address, an email, a request for a one-time passcode, and the like. The provider institution computing system 104 may send a prompt for authentication information to the user device 106 in response to receiving the user input and/or as a security measure before proceeding to the second instance. The provider institution computing system 104 may receive the authentication information and, in response, send, a notification to the user device 106. The notification may include an indication of verification of the authentication information, a code to use to access the second instance and/or the one or more products, etc. For example, the transaction device 140 may compare a username passcode combination to a stored username passcode combination associated with the transaction and verify the access credential if the combinations match. In another embodiment, the ATM and/or the provider institution computing system 104 may validate the access credential by receiving a QR code, PIN, or other access credential logged, stored, or associated with the transaction.

The access credential associated with the transaction may include a biometric (e.g., fingerprint, face scan, eye scan, photograph, etc.), a personal identification number, a passcode, a username and password combination, a token (e.g., a data payload stored on the user device 106), a barcode, a quick response (QR) code, or another suitable credential. In some embodiments, the access credential is specific to the one or more products generated in the second instance and/or responsive to the first transaction, to a particular user, etc. For example, the transaction device 140 may be configured to generate a QR code associated with a user account, a second instance at a particular time, place, location, etc., and provide the QR code to a user device 106. In other embodiments, the access credential may be communicated via a short-range wireless communication before proceeding to the second instance and/or generating the one or more products. For example, information regarding the transaction and/or the user may be provided to the user device 106 via one or more short-range wireless communications (e.g., a “tap”) between the transaction device 140 and the user device 106. The information may also be transmitted by the transaction device 140 to the provider institution computing system 104. For example, the transaction device 140 may transmit information to an NFC receiver of the user device 106. In other embodiments, a different wireless protocol is used (e.g., Bluetooth®). The user device 106 may be brought within a predetermined distance (e.g., 10 cm, 20 cm, etc.) of the transaction device 140 in order to send or provide a wireless transmission of a payload (e.g., data package) from a wireless transceiver (e.g., an NFC chip) embedded on the transaction device 140 to a wireless receiver (e.g., NFC reader) of the user device 106. The data package or payload may include the information indicative of the ATM and/or the one or more products associated with the transaction. The access credential may have additional restrictions, such as requiring a combination of credentials to obtain the one or more products (e.g., requiring a personal identification code and a biometric, requiring a QR code and a username password combination, etc.). Once the user has been authenticated, the ATM may proceed with the transaction (e.g., the second transaction) associated with the one or more products.

In some embodiments, the method 200 may further include step 260 of causing, by the first processor, a graphical user interface (GUI) of the ATM to display the one or more products. For example, in the second instance, the display screen 184 may be divided into regions each representing one of the one or more products. The user may select one of regions associated with the one or more products, for example, via buttons adjacent to that region of the display screen. Once selected, the GUI may receive inputs such as adjusted balances, adjusted durations, or the like, and the ATM may revise and/or modify the one or more products considering the user input. In some embodiments, the ATM may determine that no product is permitted based on the user input and may prompt the user to return to the default one or more products, a set of pre-generated one or more products, or the like (e.g., the ATM may reject the received request to modify the one or more products).

At step 264, the transaction device 140 may determine a fee associated with the second transaction. In some embodiments, this step may be performed at the same time as and/or may be subsumed within step 215, step 250, etc. The fee may be associated with the completion of the first transaction and/or the user meeting the product structure of the second transaction.

At step 270, at least one of the provider institution computing system 104 and/or the transaction device 140 may perform the second transaction responsive to receiving a second user input. The second user input may be similar to the first user input (e.g., a button press, a keypad selection, receiving a signal from a mobile device, etc.). The second input may permit or otherwise activate the second transaction.

At step 274, the method may include processing the first transaction. For example, the ATM may attempt to process the $5,000 check discussed above, may permit another first transaction satisfying the transaction threshold, etc. Responsive to processing the first transaction and receiving the transaction value, the method 200 may include waiving at least a portion of the fee. In this way, rather than placing a delay or a hold on the first transaction, the ATM may proceed with one and/or both of the first or second transaction, and upon validating and/or completing the first and/or second transaction, resolve or otherwise terminate the second transaction. In other words, the second transaction may provide an additional layer of security to bolster the first transaction such that the first transaction is not delayed or prohibited. The method 200 may also include, responsive to processing the first transaction and not receiving the transaction value, charging at least a portion of the fee to an account of the user. For example, if the $5,000 check above is not processed, is rejected, bounces, or the like, the product structure of the second transaction may remain in place and the ATM, the provider institution, or the like may perform the second transaction with the account of the user. Additionally, the second transaction may provide security for the user against false first transactions by ensuring access to funds if the first transaction fails or is otherwise invalid.

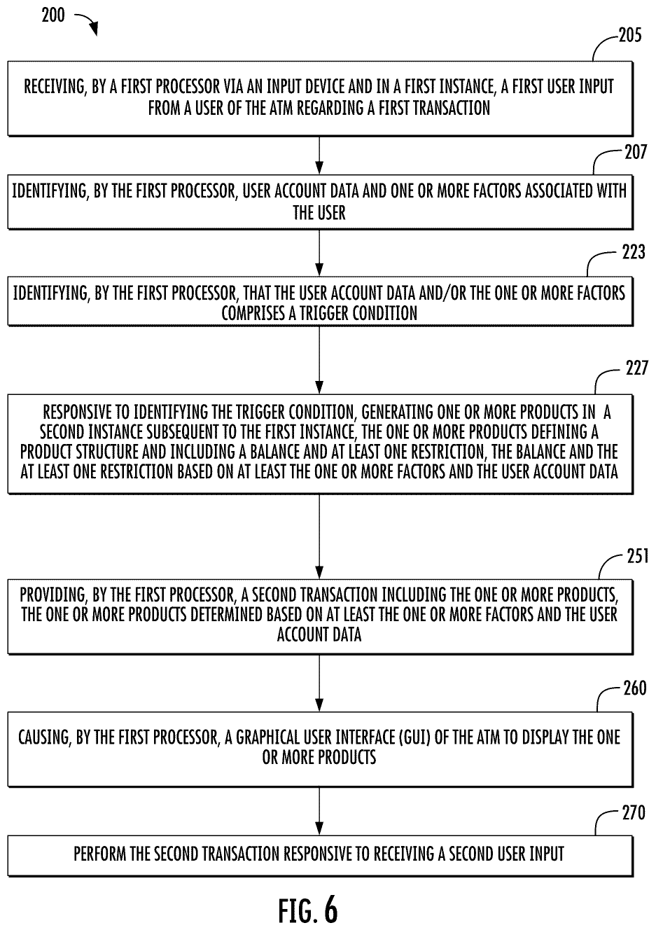

Turning to FIG. 6, another example method 200 for providing additional secure instances, associated products, and improved security functionalities via an ATM is shown, according to an example embodiment. These steps may be performed in a different order than the exemplary order shown in FIG. 6. Additionally, the shown steps may be optional, repeated, separated by additional optional steps or intervening steps, or expanded upon to include additional actions/functionalities. All such iterations of the operating process as would be apparent to a person of ordinary skill in the art are contemplated within this disclosure.

Similar to step 205 discussed with respect to FIG. 5, the method 200 in FIG. 6 may include the transaction device 140, in a first instance, receiving, via an input device, a first user input from a user of the ATM regarding a first transaction. Additionally, the method 200 may include step 207 discussed above, and, responsive to receiving the first user input, the transaction device 140 may receive, by the processing circuit 132, at least one of user account data and/or one or more factors associated with the user.

At step 223, the transaction device 140 may identify, detect, or otherwise receive an indication, by the first processor, that at least one of the user account data and/or the one or more factors comprises a trigger condition. The trigger condition may be indicative of a user, user account, or the like that may be inclined, may benefit from, and/or that may otherwise receive the second instance including the one or more products. The trigger condition may be stored, generated, determined by, and/or otherwise provided by the ATM system 102, the provider institution computing system 104, and/or any component thereof. For example, the provider institution computing system 104 may designate a list, look-up table, a set of account criteria, or the like as the trigger condition and communicate the trigger condition(s) to the one or more ATM systems 102. The ATM systems 102 may then monitor, detect, etc. user transactions for indications of the one or more trigger conditions to determine when/which users to provide the one or more products to (e.g., select one or more products may be provided/generated based on users that satisfy the trigger condition). Further, the ATM systems 102 may utilize the trigger condition(s) to generate the one or more products in real time and based upon the trigger condition, user account data, and/or the one or more factors. In even further embodiments, the trigger condition(s) may cause the ATM system 102 to receive one or more pre-approved, pre-generated, default, etc. products associated with one or more specific trigger condition(s).

For example, in some embodiments, the trigger condition may include a transaction validity score satisfying a transaction validity threshold. For example, the presence of one or more indications of fraud (e.g., a user image mismatching a designated account owner image, a user voice mismatching a designated account owner voice, a user button press cadence mismatching a standard account owner button press cadence, multiple incorrect PIN attempts, user location/transaction amount/transaction frequency straying from a normal location/normal transaction amount/transaction frequency, etc.), higher transaction values, shorter account ages, increased overdraw events associated with the account, and the like may indicate that a transaction has a low transaction validity score. The transaction validity score may be based on an algorithm, heuristic, or the like using the account data and/or the one or more factors as inputs. For example, a weighted algorithm, an artificial intelligence/machine learning engine, etc. may determine and/or assign a validity score to the transaction and compare it to the transaction validity threshold. In response to determining that the transaction validity score falls below the transaction validity threshold, the ATM system 102 may generate the one or more products and prompt the user to proceed via a second transaction (e.g., in a second instance that may require heightened data security and/or authentication).

In other embodiments, the trigger condition may include an account balance satisfying a threshold balance (e.g., an account balance of the user falling below a minimum threshold balance and/or an account balance of the user falling above a maximum threshold balance). In the former example, the ATM may detect that a user having a low account balance may be in need of additional funds and generate one or more products in the second instance to provide the user with an advance associated with a product structure, one or more restrictions, or the like. In some embodiments, the trigger condition may include a predefined number of account overdraw events satisfying an overdraw threshold (e.g., a number of overdraw events in the last six months exceeding a set number of overdraw events, a user overdrawing more than a predefined amount, etc.). The ATM may detect that the user data satisfies the overdraw threshold and generate one or more products aimed at preventing further overdraws (e.g., providing the user additional transactional flexibility). In still further embodiments, the trigger condition may include one or more of a user account age, credit score, income, etc. satisfying an associated threshold).

Additionally, the one or more trigger conditions may include a user transaction history meeting, matching, overlapping, or otherwise comparing to a predefined transaction pattern. For example, the transaction pattern may be predefined by the ATM system 102, the provider institution computing system 104, or the like. The predefined transaction pattern may be generated by an algorithm, heuristic, etc. and may indicate that the user may be likely to accept the one or more products. For example, the transaction pattern may include purchases within six months indicating a home or property renovation (e.g., receipts for paint, tools, lumber, nails, roofing tiles, dry wall, insulation, pipes, etc.). The transaction pattern associated with this example may cause the ATM to provide the one or more products to assist with the home renovation project (e.g., to provide a microloan to fund additional renovations). The ATM system 102 and/or the provider institution computing system 104 may determine an overlap, correlation, match, or otherwise determine that the user transaction history satisfies the transaction pattern trigger condition based on a look-up table including pre-defined qualifying transactions, an algorithm configured to detect related transactions, an artificial intelligence and/or machine learning engine configured to approximate a closeness between the user transaction history and the transaction pattern, or the like.

At step 227, the transaction device 140, responsive to identifying the trigger condition, may generate, receive, and/or provide the one or more products in the second instance subsequent to the first instance. As described above, the one or more products may define a product structure, include a balance, and/or have at least one restriction. The balance, product structure, and the at least one restriction may be based on at least the one or more factors and the user account data. For example, a short user account age may lower the balances available for the one or more products.

At step 251, the transaction device 140 may provide, by the first processor, a second transaction (e.g., in the second instance having heightened data security measures and/or requiring additional layers of authentication) including the one or more products. For example, like method 200 discussed with respect to FIG. 5, the method 200 of FIG. 6 may include the ATM establishing a wireless connection (e.g., an encrypted connection) between the ATM and the provider institution computing system 104, receiving one or more access credential, biometrics, etc. The method 200 may then proceed to steps 260 and 270 discussed above which include causing, by the first processor, a graphical user interface (GUI) of the ATM to display the one or more products and performing the second transaction responsive to receiving a second user input.

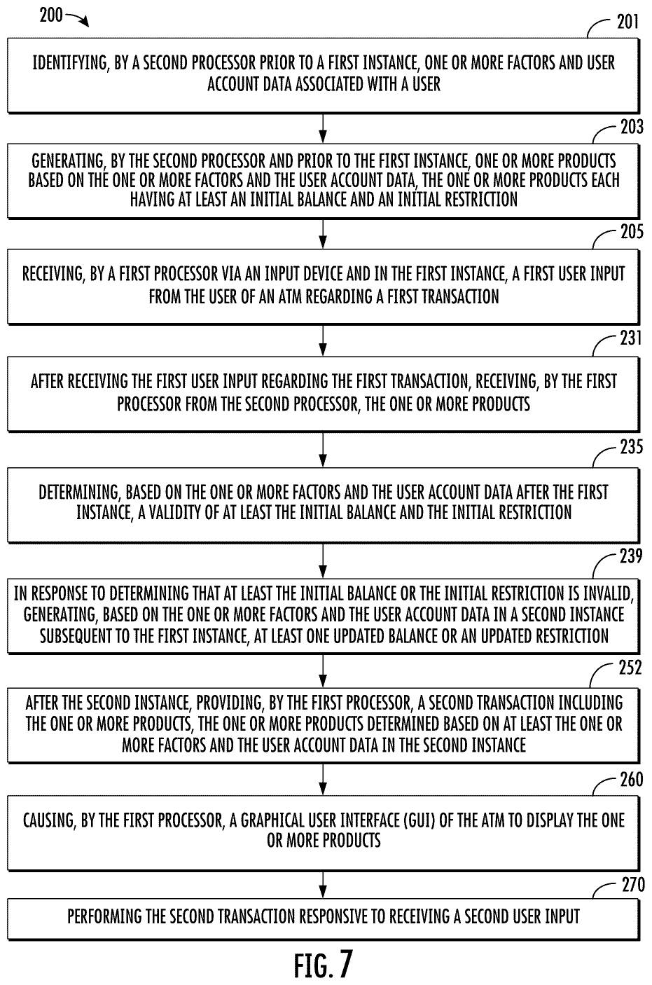

Turning to FIG. 7, another example method 200 for providing additional secure instances, associated products, and improved security functionalities via an ATM is shown, according to an example embodiment. In the method 200 shown in FIG. 7, the one or more products may be generated before the user accesses the ATM. In other words, the one or more products may be pre-approved, pre-generated, and/or one or more users may pre-qualify to receive the one or more products based on, for example, user account data, one or more factors associated with the user, or the like meeting a trigger condition in place before the user accesses the ATM. Accordingly, FIG. 7 may include an embodiment of the method 200 where the ATM system 102 receives one or more pre-approved, pre-generated, default, etc. products associated with one or more specific trigger condition(s). These steps may be performed in a different order than the exemplary order shown in FIG. 7. Additionally, the shown steps may be optional, repeated, separated by additional optional steps or intervening steps, or expanded upon to include additional actions/functionalities. All such iterations of the operating process as would be apparent to a person of ordinary skill in the art are contemplated within this disclosure.

At step 201, the method 200 may include identifying, detecting, and/or otherwise receiving an indication of, by a processor (e.g., a second processor) prior to a first instance at the ATM, one or more factors and/or user account data associated with a user. In some embodiments, the ATM may establish a connection with the provider institution computing system 104 and/or detect data already present on the ATM to receive the one or more factors and/or the user account data. The processor may include, for example, one or more processors associated with the provider institution computing system 104 such as the processing circuit 152, the processor 154, etc. In this way, the provider institution computing system 104, the ATM system 102, or another component may identify, detect, or otherwise receive an indication of one or more users who may be pre-determined to receive the one or more products. As discussed below, the one or more products may be initially generated at or around the time of pre-approval, pre-determination, etc. The one or more products may then be validated, updated, revised, and/or otherwise provided to the user of the ATM when the user accesses the ATM (e.g., after an amount of time such as a day, week, month, year, etc. passes between the initial generation and the time the user accesses the ATM).

At step 203, the method 200 may include generating, by the processor (e.g., the second processor) and prior to the first instance at the ATM, the one or more products based on the one or more factors and/or the user account data. Because the one or more factors and/or the user account data may change between the time of generation and the time that the user access the ATM (e.g., the time the products are provided to the user), the one or more products may each have at least an initial balance, an initial product structure, and/or an initial restriction. The initial balance, initial product structure, and the initial restriction may be similar to the balance, product structure, and restrictions discussed above but may be subject to change (e.g., based on a change in the user account data, the one or more factors, etc.).

At step 205, like steps 205 described above, the transaction device 140 may receive, by a first processor via an input device and in the first instance, a first user input from the user of an ATM regarding a first transaction. In some embodiments, step 205 may occur later in time than steps 201 and/or steps 203.

At step 231, the transaction device 140, after receiving the first user input regarding the first transaction, may receive, by the first processor from the second processor, the one or more products. In some embodiments, the first processor and the second processor may be the same (e.g., a processor of the ATM) and may receive the pre-generated products, for example, from the provider institution computing system 104, the memory 136 of the ATM, or another suitable component. Step 231 may be similar to step 230 in that the ATM receives the one or more products. However, in some embodiments, the one or more products may be generated by the provider institution computing system 104, the ATM, etc. in advance of the user accessing the ATM. Further, the ATM may receive the one or more products (e.g., the pre-generated, default, pre-approved, etc. products) in response to any of the criteria above such as a transaction exceeding a transaction threshold, identifying a trigger condition, or the like.

At step 235, based on the one or more factors and/or the user account data after and/or at the time of the first instance (e.g., at the time of the second instance, after the initial products are generated, etc.), the transaction device 140 identifies, determines, and/or otherwise receives an indication of a validity of at least the initial balance and the initial restriction. For example, step 235 may include determining whether any feature of the one or more products and/or the data from which the one or more products was generated is invalid, has changed, or otherwise warrants revision of the one or more products. In some embodiments, the transaction device 140 and/or the provider institution computing system 104 may initialize a product validation process, whereby the ATM receives updated/current information associated with the user and/or the products before proceeding with the second instance and/or conducting the second transaction. The product validation process may include connecting to and/or communicating with the provider institution computing system 104, a third-party institution computing system, or any other information source over the network 110 (e.g., a database of prevailing interest rates). The provider institution computing system 104 and/or the transaction device 140 may generate and provide a prompt or launch a security application via which the transaction device may receive updated information, confirm the accuracy of previous information, and/or authenticate the identity of the user. The information may include any one or more of a password, a PIN (personal identification number), a user ID (e.g., a username, an alpha, numeric, or alphanumeric value regarding the user, etc.), an answer to a verification question, a biometric (e.g., a picture of the user's face, a fingerprint, a voice sample, a retina scan, etc.), information indicative of the user's possession of a transaction card and/or the user mobile device 106, and/or a combination thereof. One or more of these pieces of authentication information may be transmitted to the provider institution computing system 104 and/or the third-party institution computing system to receive updated user account data and/or one or more updated factors. Depending on the authentication information prompted for, authentication of the user and/or the transaction may be structured as a multi-factor authentication. The transaction device 140 and/or the provider institution computing system 104 may verify the validity of the received authentication information by determining whether the received authentication information matches corresponding authentication information stored by the provider institution computing system 104 (in the accounts database 155, for example) or stored by the third-party institution computing system.

In an example embodiment, the method may include determining that the one or more initial products is valid by (1) comparing the updated user account data, the updated factors, and/or a new set of generated products (e.g., at the time that the user accesses the ATM) with the initial user account data, the initial factors, and the initial products and (2) determining whether a difference between the initial/updated account data, the factors, and/or the products satisfies an acceptability threshold (e.g., falls within an acceptable range of differing values, exceeds an acceptability threshold, sufficiently overlap, and/or otherwise are generated based on the same data). The determination may be made by comparing the magnitude of the difference between the balances, restrictions, and/or the product structure such as via a weighted algorithm, an averaging process, an artificial intelligence and/or a machine learning engine, etc. Responsive to determining that the one or more initial products is valid, the method may proceed with steps 252, 260, and 270 of presenting the initial products and performing, by at least one of the transaction devices 140 and/or the provider institution computing system 104, the second transaction. The method 200 may also include determining that the one or more initial products is invalid by comparing the new set of generated products with the initial products and determining whether the product difference does not satisfy the acceptability threshold or the like described above (e.g., a magnitude of the difference between values falls outside an acceptable range, the acceptability value falls below an acceptability threshold, and/or the updated data is above a certain percentage difference from the initial data, etc.).

At step 239, the transaction device 140 may, in response to determining that at least the initial balance or the initial restriction is invalid, generate, based on the one or more factors and the user account data in a second instance subsequent to the first instance (e.g., based on the updated account data and/or the updated factors), at least one updated balance or an updated restriction. In this way, the method 200 may account for changes that occur between the initial pre-approval of the products and rectify the products by considering the changes at the time the user accesses the ATM to generate, revise, and/or otherwise provide updated products based on the current data.

At step 252, similar to steps 251 and 250, the transaction device 140 may include, after the second instance, providing, by the first processor, a second transaction including the one or more products. The one or more products may include the initial products and/or the products determined based on at least the one or more factors and the user account data in the second instance. Accordingly, at this step, the ATM may receive the initial products to provide to the user and/or one or more updated products to provide to the user.

The method 200 may then proceed to steps 260 and 270 discussed above which include causing, by the first processor, a graphical user interface (GUI) of the ATM to display the one or more products and performing the second transaction responsive to receiving a second user input.

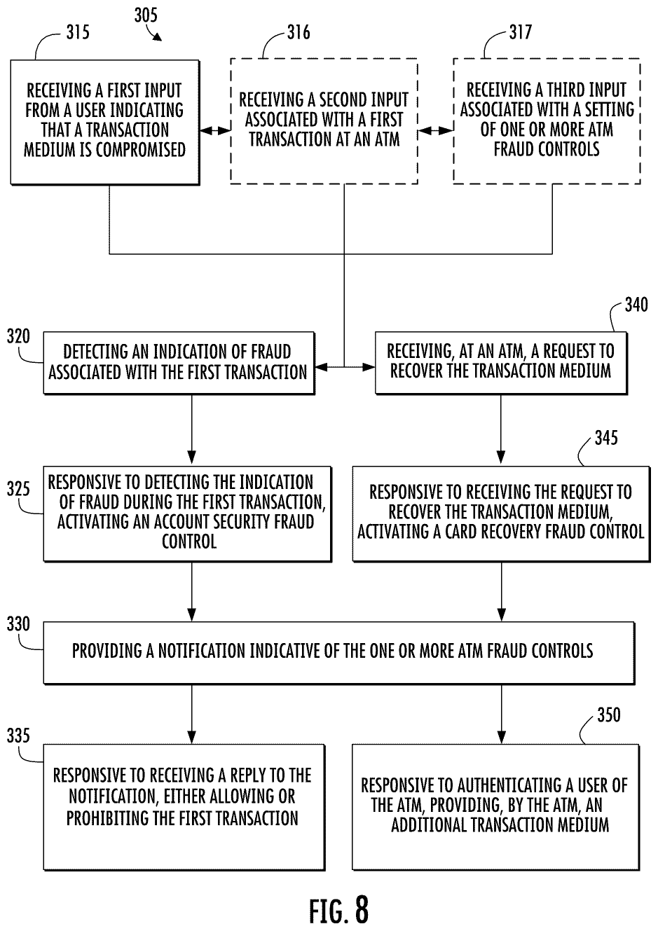

Turning to FIG. 8, an example method 305 is shown for an implementing enhanced fraud controls and transaction medium recovery via an ATM interoperable with the features discussed above, according to an example embodiment. These steps may be performed in a different order than the exemplary order shown in FIG. 8. Additionally, the shown steps may be optional, repeated, separated by additional optional steps or intervening steps, or expanded upon to include additional actions/functionalities. In some embodiments, the ATM may be configured to perform any or all of the steps shown in FIGS. 5-8 or any combination thereof. All such iterations of the operating process as would be apparent to a person of ordinary skill in the art are contemplated within this disclosure.

At step 315, the method 305 may include receiving, via an input device of the transaction device 140 such as a touch screen, keypad, or the like, a first input from a user indicating that a transaction medium is compromised. The first input may be received at the ATM via one or more I/O devices 182, via a user device 106, or via any device over the network 110. In some embodiments, the first input may include a screen tap, a request to report that a card is compromised (e.g., the card is lost, stolen, destroyed, inactive, etc.), or the like. In other embodiments, the first user input may include a request for a new transaction medium. The request may include that the ATM and/or provider institution computing system 104 collect data regarding use of the compromised transaction medium and report the data to the user, to law enforcement authorities, etc. The information may include an incorrect PIN/passcode/biometric received at an ATM, a transaction request received at a location away from/outside of a normal location of the account holder (e.g., the user), a request to perform a transaction above a transaction limit, a request associated with a blocked/prohibited party, or the like. Authentication, such as a login and duo-authentication on a mobile application or any one of the authentication methods discussed herein, may be required by the user before the ATM may receive the first input indicating that the transaction medium (e.g., an ATM card) is compromised.

At step 316, the method 305 may include receiving (e.g., at the transaction device 140) a second input associated with a first transaction at an ATM. The second user input at step 316 may include a selection of a transaction involving a user account, a user ATM card, or the like. The transaction may be associated with a withdrawal of funds, a bill payment, a fund transfer, a donation, and/or the like. The second input may be received via a button press, a keypad selection, a wireless command, etc. For example, the ATM may display multiple potential selections or prompts such as “insert card,” “donate funds,” or “store belongings.” Prompts and/or selections such as “store belongings” may identify transactions involving non-monetary media. Other suitable second user inputs include button presses identifying item rental services (e.g., rent shoes, rent keys, rent binoculars, rent umbrellas, etc.) and selections allowing for item exchanges (e.g., exchange phone for cash, exchange currency for envelope/stamps, or the like). In other embodiments, the second user input may be received by the ATM from a user device 106. For example, the ATM may receive a communication from a user device 106 requesting that the ATM launch a program/process associated with a transaction involving monetary and/or non-monetary media. In this way, the method 305, at step 316, may include monitoring any transaction at one or more ATMs for one or more indications of fraud. As explained herein, the indications of fraud may be designated, set, or otherwise established by the user, the provider institution computing system 104, or the like. The indications of fraud may include suspicious transaction patterns (e.g., multiple incorrect PIN entries, multiple transactions from the same ATM card from different locations/states/countries within a short period of time, etc.).

In some embodiments, the method 305 may include step 317 of receiving a third input associated with a setting of one or more ATM fraud controls. At this step, a user may, for example via a user device 106, activate, deactivate, edit, revise, customize, or otherwise interact with one or more settings and/or ATM fraud controls. For example, the user may opt in to a fraud control that permits the ATM to temporarily capture the likeness of an individual accessing the ATM with a designated transaction card and compare the likeness to a designated image/photo before deleting the data associated with the likeness. A mismatch between the likeness of the individual at the ATM and the image of the designated user may indicate a different, unauthorized individual accessing the ATM with the ATM card. Similarly, the third input may include opting in and/or receiving a voice sample, a key-selection/touch screen/button press cadence, a car color, a car make, a car model, a transaction limit, a transaction location range, and/or any other suitable settings or fraud controls. In some embodiments, the third input may include one or more criteria (e.g., events, conditions, occurrences, or the like) specified by a user and designated to be indicative of fraud. For example, the ATM may receive, via the IO device 182, the user mobile device 106, and/or the network 110, an indication that transacting from a certain location is prohibited/suspect, that using a designated ATM is prohibited/suspect, that transactions involving certain recipients are prohibited/suspect, or any other suitable criteria. Accordingly, the ATM may monitor transactions for the criteria (e.g., defined by the user) as indicative of fraud.

In some embodiments, the method may begin and/or proceed between any one or more of steps 315, 316, and/or 317 before proceeding to steps 320-350. For example, in some embodiments, the method 305 may only include and/or skip any one of step 315, 316, and/or 317. In some embodiments, all of steps 315, 316, and/or 317 may occur in any combination. As one example, step 317 may occur chronologically first by an ATM receiving a (third) input via a mobile device activating a likeness comparison program. Step 315 may occur second by an ATM across the country detecting a mismatch between the likeness associated with the account and the appearance of an individual present at the ATM. Step 316 may the occur by the user going to their local ATM to, for example, receive a replacement ATM card. Following steps 315, 316, and/or 317, the method 305 may generally proceed with one or more account security fraud control steps (e.g., steps 320, 325, 330, and/or 335) and/or one or more card recovery control steps (e.g., steps 340, 345, 330, and/or 350). In some embodiments, a step may be associated with one or more types of ATM fraud controls not limited to account security control steps and/or card recovery control steps. For example, in some embodiments, multiple steps may be combined, executed concurrently, etc.

At step 320, the method 305 may include detecting an indication of fraud associated with the first transaction and/or a transaction at an ATM. For example, the transaction device 140 may establish a wireless connection with the provider institution computing system 104 and transmit one or more messages containing data regarding or indicative of the first transaction and/or user input. For example, the first transaction may be monitored by one or more systems, sensors, software packages, circuits, or the like associated with the ATM. Specifically, the first transaction may be monitored for one or more indications of fraud. In some embodiments, receiving identification information associated with a user account and/or an ATM card associated with the user account may activate/begin/trigger the step of monitoring and detecting the first transaction for an indication of fraud. Detecting the indication of fraud may include detecting indications predefined by the provider institution as indicative of fraud (e.g., transactions at disparate locations within a short period of time), indications designated/set as criteria indicative of fraud by the user in step 317 (e.g., transactions from the ATM at the corner of Shady Street and Commerce Avenue are indicative of fraud), flagged based on a compromised transaction medium as indicated in step 315 (e.g., card number X is lost/stolen and transactions using it are indicative of fraud). Further, detecting indications of fraud may include comparing a biometric of the individual at the ATM with a known biometric (e.g., provided via an opt-in feature) of the account owner. For example, the account owner may provide their image, voice sample, fingerprint, eye color, or the like. Detecting a different biometric by the individual at the ATM using the transaction media may be flagged as fraudulent. Other suspect differences in transaction pattern discussed herein and the like may also be detected such as the individual at the ATM using a different hand (left vs. right) to press the keypad than normal, transacting from a drive-through ATM in an unknown vehicle, pressing the input/output devices at a different pace (e.g., slowly typing in a long username and password combination indicating a lack of familiarity with the combination vs. rapidly typing in the username and password combination indicating familiarity), or other suitable indications.

At step 325, the method 305 may include, responsive to detecting the indication of fraud during the first transaction, activating an account security fraud control. For example, the provider institution computing system 104, the ATM, and/or another component of the system may send an alert indicating suspected fraudulent activity and requesting permission before the transaction may continue. In some embodiments, the fraud control may include a notification/request to collect data associated with the transaction to send to the account owner/authorities. Further, the indications of fraud (e.g., a card being used that has previously been designated as compromised) may automatically trigger data collection (e.g., photograph comparison, voice recording, or the like) at the suspect transaction to be reported to the provider institution, law enforcement, or the like. In some embodiments, the transaction may cause a request to be sent to a backer, advisor, or designated individual for approval (e.g., a guardian, a parent, etc.).

At step 330, the method 305 may include providing a notification indicative of the at least one (account security) fraud control. The notifications indicative of the fraud controls described in step 325 may include any suitable format of notification such as a push notification to a registered user device 106, a OTP sent to a mobile application and required to proceed at the ATM, an email indication that a transaction is occurring at the specific ATM including a request to continue or terminate the transaction, or another suitable notification. The notification may include a prompt for a reply (e.g., an “approve” or “deny” selection, a “report suspicious activity” link, or the like).

At step 335, the method 305 may include responsive to receiving a reply to the notification, either allowing or prohibiting the first transaction. For example, upon receiving an indication of approval, the transaction may continue and upon receiving an indication of denial, the transaction may be prohibited, data may be collected and reported to authorities, and/or the like.

At step 340, the method 305 may include receiving, at the ATM, a request to recover the transaction medium. For example, at this step, the ATM may create a file, log, data object, or the like to track and/or manage the request to recover, create, and/or otherwise provide the additional transaction medium. The request to recover the transaction medium may be directed to a designated (e.g., a local, favorite, etc. ATM and/or a nearest ATM having card recovery capabilities such as the card preparation apparatus 190). In some embodiments, the request may be sent via a mobile application and may trigger the account security fraud controls with respect to the card discussed above. For example, a card reported compromised may activate a fraud control setting at all ATMs. The ATM may accept the card yet collect data regarding the individual using the card (photograph, voice sample, etc.) and automatically send the data to the account owner and/or other designated authorities for investigation.

At step 345, the method 305 may include, responsive to receiving the request to recover the transaction medium, activating a card recovery fraud control. The card recovery fraud control may include initiating a process of receiving a new, temporary, permanent, etc. transaction medium (e.g., a replacement transaction medium) at a designated ATM. Further, the card recovery fraud control may include automatically converting any transaction via the compromised transaction medium, the compromised transaction medium, or the like as a product described above (e.g., a microloan) requiring access to the second instance having heightened security and subject to at least one restriction, the balance, and the product structure. Upon receiving an indication that the transaction is legitimate and not fraudulent, the product may be converted to a traditional transaction (e.g., any fee, restriction, or the like associated with the product may be waived).

During and/or following step 345, the method 305 may additionally include the step 330 of providing a notification indicative of the at least one (card recovery) fraud control. In addition to the notifications described above with respect to the account security notifications, the method 305 may include the step of providing, by at least one of the provider institution computing system 104 and/or the transaction device 140, a prompt to a user mobile device 106, an ATM, etc. to authenticate the user to receive an additional (e.g., a replacement) transaction medium. The prompt may include a selection selectable via an input/output device 182 of the transaction device, text displayed via ATM display 184, an audio message instructive of steps to proceed with the card recovery process (e.g., “Visit www.Provider.com on your mobile device to sign in and activate card printing capabilities of this ATM.”), or the like. Such an arrangement may allow additional authentication factors (e.g., one-time passcode, fingerprint or other biometric, etc.) to be used as a second or additional factor of authentication.

At step 350, the method 305 may include responsive to authenticating a user of the ATM, providing, by the ATM, an additional transaction medium. The transaction device 140 and/or the provider institution computing system 104 may authenticate the user of the ATM in any manner discussed above. For example, the ATM may receive additional user information responsive to the prompt to convert the non-monetary media into an additional (e.g., replacement) transaction medium. The additional user information may include any information necessary to access the customer account. For example, the information may include a social security number, an account username and password combination, a biometric, a credit score, or other suitable information. In some embodiments, the ATM may dispense or provide a transaction medium such as a transaction card, a transaction ID, a QR code, or a similar token or transaction media via which the user may make purchases or access funds of the customer account. Further, one or more limitations may be placed on the dispensed (e.g., replacement) transaction medium. For example, the transaction medium may be limited to a designated transaction amount, limited geography of use, limited transaction types, limited to transacting in the form of one or more products (e.g., microloans rather than withdrawals and deposits), etc. until the authenticity of the transaction medium is verified (e.g., by an appointment with the provider institution, by subsequent authentication steps, by cancellation of the compromised transaction medium, or the like). In some embodiments, the additional transaction medium may carry a fixed balance treated as a product (e.g., microloan) that is paid from account balance and that transitions to being treated as a withdrawal once the account security is confirmed/authenticated. In further embodiments, the additional transaction medium may expire after a predefined amount of time.

To provide the additional (e.g., replacement) transaction medium, the ATM may establish a connection with the provider institution computing system 104 and dispense a new transaction medium to the user by converting the non-monetary media via the transaction medium control circuit 144 and the card preparation apparatus 190. In some embodiments, the ATM may provide a digital or physical receipt confirming the transaction and associating the transaction with an identifier (e.g., a transaction number, code, time stamp, etc.). The receipt may include a temporary transaction number and PIN code as a replacement card number and CVV. In other embodiments, responsive to receiving and validating the access credential associated with the transaction, the transaction device 140 produces, via the at least one media aperture 181 (or via the output device, the door 199, etc.), the additional transaction medium after converting the non-monetary media from the storage repository 196 into the transaction medium for the user. For example, in some embodiments, upon receiving and validating the access code, the transaction device 140 may cause the door 199 to actuate from the locked state to the unlocked state. The user may then open the door 199 and retrieve the replacement transaction medium. In another embodiment, the transaction device 140 may cause the card preparation apparatus 190 to transfer the at least one non-monetary media (e.g., a blank transaction card) from the storage repository 196 and, in response to receiving the access credential associated with the transaction, print new ATM card information on the blank transaction card, program a chip/magnetic stripe of the card, etc. For example, an internal lift, claw, cartridge, or the like may retrieve the non-monetary media, transfer the non-monetary media from the storage repository 196 to the card preparation apparatus 190, then present the non-monetary media converted into the additional transaction medium to the user.

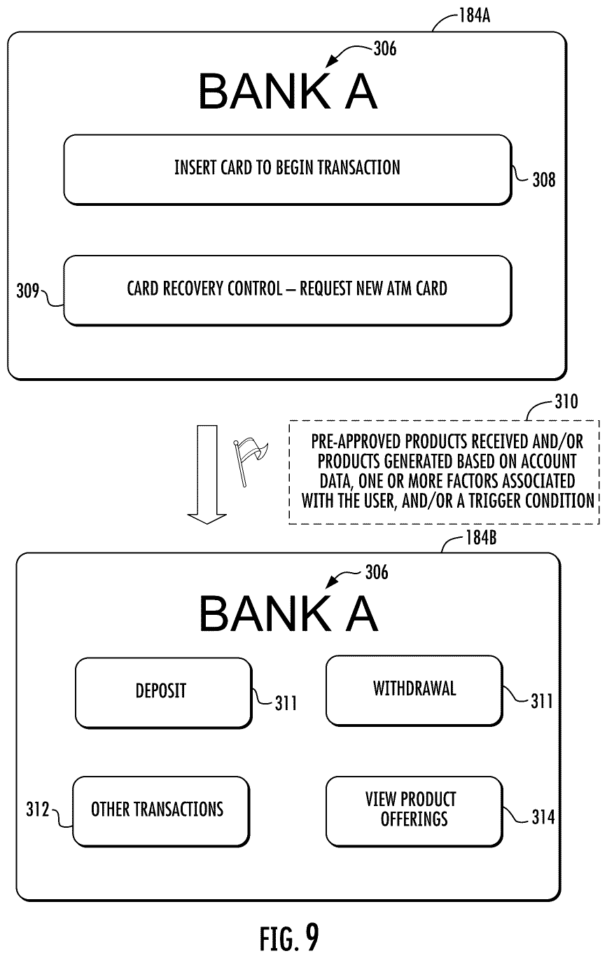

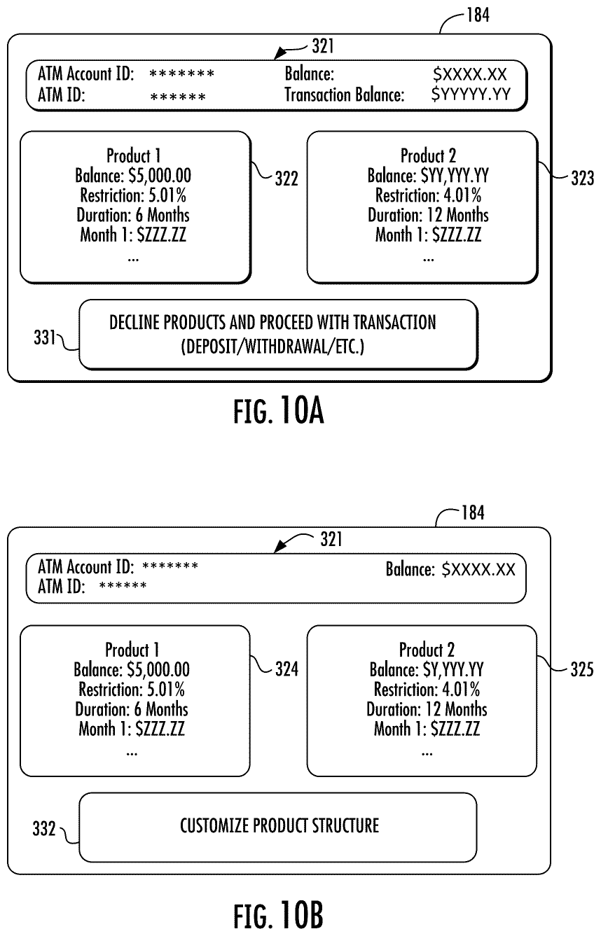

Turning to FIGS. 9-10, example user interfaces of an ATM interoperable with the systems and methods disclosed herein are shown, according to an example embodiment. As shown in FIGS. 9-10, the transaction device 140 may include a display 184 configured to provide one or more graphical user interfaces (GUIs) for providing expanded functionalities directed to customers and non-customers of the provider institution. The display 184 may be divided and/or subdivided into one or more zones. For example, some zones of the display may be touch sensitive, while others may not be touch sensitive and may merely display information. Other zones may be selectable via buttons, dials, knobs, or the like positioned adjacent to the display 184 or via an I/O device 182 such as a keyboard, cursor, etc. The display 184 may include one or more identifiers 306 associated with the provider institution. In FIGS. 9-10, the identifier 306 indicates that the transaction device 140 is an ATM associated, operated, and/or provided by Bank A.

As shown in the first display 184a of FIG. 9, the ATM may present an initial selection for a user. The initial selection may include one or more prompts 308, 309 for user inputs that may distinguish between initiating a transaction and/or initiating ATM fraud controls (e.g., card recovery controls as shown in FIG. 9). For example, as shown in the first display 184a, customers may be prompted to begin transactions by prompt 308 instructing customers to insert their Bank A transaction card to begin a transaction.

Turning to the second display 184b of FIG. 9, an example GUI is shown after prompt 308 is activated (e.g., a user inserts an ATM card and and/or enters a PIN to begin a transaction). The transaction device 140 may present a second selection GUI such as the second display 184b. The second display 184b includes a prompt 311 for “traditional” ATM transactions such as currency deposits and withdrawals. The ATM may also include a prompt 312 for “other transactions” such as bill pay transactions, funds transfers, or the like.

In the first instance, as shown in box 310, (e.g., upon receiving the user account data and/or factors associated with the user), the ATM may (1) receive an indication that the user has been pre-approved for products, (2) generate products in real time based on the account data, factors, and/or information provided at the ATM such as a withdrawal/deposit amount, (3) detect a trigger condition and provide an offering of products associated with the trigger condition, or the like. For example, the ATM may detect a transaction history indicating a home renovation and thus displace prompt 314 directed to product offerings to assist the user with the home renovation. Prompt 314 may also direct users to products that have been pre-approved and/or generated in real-time based on trigger conditions associated with user account data and/or the one or more factors associated with the user.

Following a selection of prompt 311 and/or prompt 312, the transaction device 140 may present a follow-up display requesting user information/data sufficient to define the requested transaction (e.g., a transaction value). The user may be prompted/queried if they would like to proceed with the transaction in the form of the one or more products (e.g., because a transaction value satisfied the transaction threshold, because a transaction validity score fell below a validity threshold, etc.). Accordingly, the transaction device 140 may request an address, name, SSN, username and passcode combination, PIN code, biometric, an email address, a mobile phone number, or other suitable authentication information to access the secure second instance containing the one or more products.

Proceeding to FIG. 10a, the ATM may display a GUI associated with the second instance containing the one or more products generated based on the user data, the one or more factors, and/or the transaction data. The account data identifier 321 may display information indicative of the account, its status, and its associated ATMs, users, etc. For example, the account data identifier 321 shown in FIGS. 10A and 10B provides an ATM account ID (e.g., account number), an ATM ID (e.g., identified associated with the ATM), a current account balance, and a current requested balance for the pending transaction (e.g., the first transaction). For example, for a withdrawal of “$YY,YYY.YY,” may exceed the transaction threshold and prompt the user to proceed with the one or more products (e.g., one or more microloans). As shown in FIG. 10a, prompt 322 may include product 1 may include a balance of at least a portion of the transaction value (e.g., $5,000.00 out of $YY,YYY.YY), a restriction (e.g. interest rate of 5.01%), and a product structure including a duration, transaction amounts, and the like. Prompt 323 may include a product for the entire balance of the transaction having a different restriction and product structure. In some embodiments, the user may select prompt 331 to decline the products and proceed with the transaction (e.g., accept a delay or hold or alternative authentication process) or proceed with a different transaction.

Turning back to FIG. 9, the user may select the “View Product Offers” prompt 314 and, after being authenticated and accessing the secure second instance, reach the portion of the second instance shown via the GUI in FIG. 10b. In FIG. 10b, products 324, 325 pre-approved for the user, generated based on current user account data, trigger conditions, or the like may be displayed for the user to consider. The user may further be permitted to select prompt 332 to customize the product structure (e.g., change a product balance, etc.) and/or to decline the products.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings. Further, the features present in one drawing may be combined, included, or otherwise interoperate with the features disclosed in another drawing.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, a microphone, a camera (e.g., motion sensing/detecting camera), joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A system comprising:
an automated teller machine (ATM) associated with a provider institution computer system,
the system including at least one first processor and at least one first memory having instructions stored thereon that when executed by the at least one first processor, cause the at least one first processor to:
receive, via an input device and in a first instance, a first user input from a user of the ATM regarding a first transaction;
identify at least:
one or more factors associated with the user, and
user account data;
in a second instance subsequent to the first instance, provide a second transaction including one or more products, the one or more products determined based on at least the one or more factors associated with the user and the user account data; and
cause a graphical user interface (GUI) of the ATM to display the one or more products.

2. The system of claim 1, wherein the instructions, when executed by the at least one first processor, further cause the at least one first processor to:
identify that the first transaction involves a first transaction value satisfying a threshold value;
determine a hold status of the first transaction;
after determining the hold status, generate the one or more products, the one or more products including at least a portion of the first transaction value and having at least one restriction; and
perform the second transaction responsive to receiving a second user input.

3. The system of claim 2, wherein:
the hold status of the first transaction is determined based on at least one of the first transaction value, the one or more factors associated with the user, or the user account data;
the one or more factors associated with the user include at least one of a user credit score, a user transaction history, or a user income;
the user account data includes at least one of an account balance, an account age, a previous account activity, an account status, or an account identifier;
the one or more products includes a microloan having a balance and defining a product structure;
the at least one restriction includes an interest rate;
wherein the instructions, when executed by the at least one first processor, further cause the at least one first processor to:
determine a fee associated with the second transaction;
at least one of:
responsive to processing the first transaction and receiving the first transaction value, waiving at least a portion of the fee, or
responsive to processing the first transaction and not receiving the first transaction value, charging at least a portion of the fee to an account of the user.

4. The system of claim 1, wherein the instructions, when executed by the at least one first processor, further cause the at least one first processor to:
identify that at least one of the one or more factors associated with the user or the user account data comprises a trigger condition;
responsive to identifying the trigger condition, generate the one or more products in the second instance, the one or more products having a balance, at least one restriction, and defining a product structure;
perform the second transaction responsive to receiving a second user input; and
wherein at least one of the balance, the at least one restriction, or the product structure is generated based on at least the one or more factors associated with the user or the user account data.

5. The system of claim 4, wherein:
the trigger condition includes at least one of:
an account value satisfying a threshold account value,
a number of account overdraw events exceeding a predefined number of account overdraw events, or
a transaction pattern associated with the user corresponding to a predefined transaction pattern;
the one or more factors associated with the user include at least one of a user credit score, a user transaction history, or a user income;
the user account data includes at least one of an account balance, an account age, a previous account activity, an account status, or an account identifier;
the one or more products includes a microloan; and
the at least one restriction includes an interest rate.

6. The system of claim 1, further comprising:
the provider institution computer system, the provider institution computer system comprising at least one second processor and at least one second memory having second instructions stored thereon that when executed by the at least one second processor, cause the at least one second processor to:
identify, prior to the first instance, the one or more factors associated with the user and the user account data;
generate, prior to the first instance, the one or more products based on the one or more factors associated with the user and the user account data, the one or more products each having at least an initial balance and an initial restriction;
wherein the instructions, when executed by the at least one first processor, further cause the at least one first processor to:
after receiving the first user input regarding the first transaction, receive, from the provider institution computer system, the one or more products; and
perform the second transaction responsive to receiving a second user input.

7. The system of claim 6, wherein:
the one or more factors associated with the user include at least one of a user credit score, a user transaction history, or a user income;
the user account data includes at least one of an account balance, an account age, previous account activity, an account status, or an account identifier;
the one or more products includes a microloan; and
the initial restriction includes an interest rate.

8. The system of claim 6, wherein the instructions, when executed by the at least one first processor, further cause the at least one first processor to:
determine, based on the one or more factors associated with the user and the user account data after the first instance, a validity of at least one of the initial balance or the initial restriction; and
in response to determining that at least one of the initial balance or the initial restriction is invalid, generate, based on the one or more factors associated with the user and the user account data in the second instance, at least one of an updated balance or an updated restriction.

9. A system comprising:
an automated teller machine (ATM) associated with a provider institution computer system,
the system including a storage repository configured to store at least one non-monetary media, a card preparation apparatus configured to convert the at least one non-monetary media into a transaction media for a user of the ATM, and at least one first processor and at least one first memory having instructions stored thereon that, when executed by the at least one first processor, cause the at least one first processor to:
receive, via an input device, a first user input indicating that a transaction medium is compromised;
receive, at the ATM, a request to recover the transaction medium;
responsive to receiving the request to recover the transaction medium, activate one or more ATM fraud controls;
provide a notification indicative of the one or more ATM fraud controls; and
responsive to authenticating the user of the ATM, provide, at the ATM, an additional transaction medium.

10. The system of claim 9, wherein the instructions, when executed by the at least one first processor, further cause the at least one first processor to:
cause the card preparation apparatus to receive the at least one non-monetary media from the storage repository after receiving the first user input;
cause the card preparation apparatus to convert the at least one non-monetary media to the additional transaction medium; and
provide, via a media aperture of the ATM, the additional transaction medium to the user.

11. The system of claim 10, the instructions, when executed by the at least one first processor, further cause the at least one first processor to:
authenticate, prior to providing the additional transaction medium to the user, an identity of the user; and wherein:
the at least one non-monetary media includes a blank transaction card;
the card preparation apparatus is configured to convert the blank transaction card to a transaction card associated with an account of the user;
the additional transaction medium is the transaction card associated with the account of the user; and
the identity of the user is authenticated via a push notification to a mobile device, a biometric, a personal identification number, a passcode, a username and password combination, a token, a barcode, or a quick response (QR) code.

12. The system of claim 9, wherein the instructions, when executed by the at least one first processor, further cause the at least one first processor to:
receive a second input associated with a first transaction at the ATM;
detect an indication of fraud associated with the first transaction;
responsive to detecting the indication of fraud, activate the one or more ATM fraud controls; and
after providing the notification indicative of the one or more ATM fraud controls, either allow or prohibit the first transaction.

13. The system of claim 12, further comprising:
a sensor coupled to the ATM, the sensor configured to collect data indicative of an identity of an individual associated with the first transaction;
wherein the instructions, when executed by the at least one first processor, further cause the at least one first processor to:
collect, via the sensor, the data indicative of the identity of the individual associated with the first transaction;
send, based on the data indicative of the identity the individual associated with the first transaction, a notification indicative of a security status of the first transaction; and
wherein the data indicative of the identity of the individual associated with the first transaction comprises at least one of a biometric, an anomaly in a transaction pattern of the user, a photo of the individual, or a voice sample of the individual.

14. The system of claim 12, wherein the instructions, when executed by the at least one first processor, further cause the at least one first processor to:
receive a third input associated with a setting of the one or more ATM fraud controls;
implement the setting of the one or more ATM fraud controls; and
wherein the setting of the one or more ATM fraud controls includes an activation, a deactivation, a transaction time designation, a transaction location designation, a transaction amount designation, a biometric designation, an ATM designation, or an alert designation.

15. A method comprising:
receiving, via an input device and in a first instance, a first user input from a user of an ATM regarding a first transaction;
identifying at least:
one or more factors associated with the user, and
user account data;
identifying at least one of:
that the first transaction involves a first transaction value satisfying a threshold value, or
that at least one of the one or more factors associated with the user or the user account data comprises a trigger condition;
responsive to identifying at least one of that the first transaction involves the first transaction value satisfying the threshold value or identifying the trigger condition, receiving one or more products, the one or more products determined based on at least the one or more factors associated with the user or the user account data;
in a second instance subsequent to the first instance, providing a second transaction including the one or more products;
causing a graphical user interface (GUI) of the ATM to display the one or more products; and
performing the second transaction responsive to receiving a second user input.

16. The method of claim 15, wherein:
the trigger condition includes at least one of:
an account value satisfying a threshold account value,
a number of account overdraw events exceeding a predefined number of account overdraw events, or
a transaction pattern associated with the user corresponding to a predefined transaction pattern;
the one or more factors associated with the user include at least one of a user credit score, a user transaction history, or a user income;
the user account data includes at least one of an account balance, an account age, a previous account activity, an account status, or an account identifier;
the one or more products includes a microloan having a balance, at least one restriction, and defining a product structure; and
the at least one restriction includes an interest rate.

17. The method of claim 16, further comprising:
generating the one or more products after the first instance;
determining a fee associated with the second transaction;
at least one of:
responsive to processing the first transaction and receiving the first transaction value, waiving at least a portion of the fee, or
responsive to processing the first transaction and not receiving the first transaction value, charging at least a portion of the fee to an account of the user.

18. The method of claim 16, further comprising:
identifying, prior to the first instance, the one or more factors associated with the user and the user account data;
generating, prior to the first instance, the one or more products based on the one or more factors associated with the user and the user account data, the one or more products having at least an initial balance and an initial restriction;
determining, based on the one or more factors associated with the user and the user account data after the first instance, a validity of at least one of the initial balance or the initial restriction; and
in response to determining that at least one of the initial balance or the initial restriction is invalid, generating, based on the one or more factors associated with the user and the user account data in the second instance, at least one of an updated balance or an updated restriction.

19. The method of claim 16, further comprising:
receiving, via the input device, an indication that a transaction medium is compromised;
receiving, at the ATM, a request to recover the transaction medium;
responsive to receiving the request to recover the transaction medium, activating one or more ATM fraud controls;
providing a notification indicative of the one or more ATM fraud controls; and
responsive to authenticating the user of the ATM, providing, by the ATM, an additional transaction medium.

20. The method of claim 16, further comprising:
detecting an indication of fraud associated with the first transaction;
responsive to detecting the indication of fraud, collecting, via a sensor, data indicative of an identity of an individual associated with the first transaction,
sending, based on the data indicative of the identity the individual associated with the first transaction, a notification indicative of a security status of the first transaction; and
after providing the notification, either allowing or prohibiting the first transaction.
